(19) United States
(12) Patent Application Publication
(10) Pub. No.: US 2006/0002315 A1
(43) Pub. Date: Jan. 5, 2006

(54) Selectively sharing screen data

(75) Inventors: David Frederic Theurer, Santa Barbara, CA (US); Bernd Oliver Christiansen, Santa Barbara, CA (US); Klaus E. Schauser, Goleta, CA (US); Thorsten Von Eicken, Santa Barbara, CA (US); Albert Alexandrov, Goleta, CA (US); Rafael H. Saavedra, Santa Barbara, CA (US)

Correspondence Address: LAHIVE & COCKFIELD, LLP., 28 STATE STREET, BOSTON, MA, 02109, US

(73) Assignee: Citrix Systems, Inc., Fort Lauderdale, FL (US)

(21) Appl. No.: 11/140,568

(22) Filed: May 26, 2005

Related U.S. Application Data
(63) Continuation-in-part of application No. 10/709,142, filed on Apr. 15, 2004.
(63) Continuation-in-part of application No. 10/709,141, filed on Apr. 15, 2004.

(51) Int. Cl. H04Q 11/00

(52) U.S. Cl. 370/261

(57) ABSTRACT

The present invention relates to systems and methods for providing screen sharing techniques to selectively share portions of the screen between a source node and a consumer node. The source node, such as the computer of a presenter of an online meeting, may transmit screen data to a consumer node, such as the computer of an attendee of the online meeting. The consumer or attendee computer uses the screen data to display the screen of the source or presenter's computer. The techniques of the present invention provide a mechanism for not sharing a selective portion of the presenter's screen during screen sharing. So, although a certain element may be displayed on the screen of the presenter, the present invention prevents an attendee from viewing the user interface element in the screen share session.

### RELATED APPLICATIONS

This present application is a continuation-in-part and claims priority to U.S. patent application Ser. No. 10/709,142, entitled “Methods and Apparatus for Synchronization of Data Set Representations in a Bandwidth-Adaptive Manner”, filed Apr. 15, 2004, and U.S. patent application Ser. No. 10/709,141, entitled “Methods and Apparatus for Sharing Graphical Screen Data in a Bandwidth-Adaptive Manner”, filed Apr. 15, 2004, both of which are incorporated herein by reference.

### TECHNICAL FIELD

The invention generally relates to selectively sharing screen data between a first computing device and a second computing device.

### BACKGROUND INFORMATION

Online collaboration products and services allow for collaboration among one or more remotely located people. Through online collaboration, information can be presented and shared live or in real-time for people to cooperate on an activity from different locations. Online collaboration may include any type and form of communication, such as video and audio, and may include web-based conferencing and other information sharing tools. For example, a presenter may use a web-conferencing tool to schedule an online meeting with one or more attendees. The meeting presenter and attendees may need to download and run software to participate in the online meeting such as to share or view the presentation, or to interact in the meeting, such as via instant messaging or chat.

A feature of many online meeting or web-conferencing tools is the ability to share the contents of a presenter's computer screen with the attendee's via a web interface and/or the Internet. For example, a presenter may present information to an audience of attendees by sharing the contents of his or her computer screen via the web-conferencing tool. The presenter may share the entire desktop area of his or her computer screen or may share only a specific application, such as Microsoft PowerPoint to show a presentation. By sharing the presenter's computer screen via the online meeting allows the attendees of the meeting to view the presenter's computer screen to see the same content the presenter sees.

Through screen sharing, the attendees may see all the presenter's interactions with the computer and the corresponding changes to the screen. For example, the presenter may share the entire desktop screen with meeting attendees. If the presenter uses the taskbar to invoke an application or selects a menu item to invoke functionality of an application, the attendees may also see these interactions via the screen sharing. Also, the online meeting or collaboration tool may display a user interface on the presenter's screen for controlling and managing the meeting. For example, the online meeting tool may have a control panel for starting, pausing and stopping the meeting, or for displaying and managing a list of attendees or for chatting with attendees. The screen sharing may show the presenter's interactions with the control panel, and may show information related to the management of the meeting, such as attendee and chat information.

In many cases, the presenter may not want to share a portion of the screen or information displayed on the screen during screen sharing, such as via an online meeting. Some of the information may be private, sensitive or confidental to the presenter. For example, the presenter may want to keep the list of attendees on the meeting tool's control panel or chat information displayed in a chat tool private during screen sharing. In another case, the presenter may want to multi-task and continue with the screen sharing but at the same time manage the online meeting. For example, the user may want to check the status of an attendee's session with the meeting or recall the name or indentity of an attendee while showing a powerpoint presentation. However, performing one of the tasks may display a user interface that covers a portion of the presentation.

In further cases, the presenter may wish to exclude the presenter's interactions with the online meeting tool from view of the attendees. The presenter's user interface interactions may be a distraction to or a distruption of the flow of the presentation or may otherwise interfer with viewing of information on the screen.

### SUMMARY OF THE INVENTION

The present invention relates to systems and methods directed towards techniques for providing selective screen sharing between one computing device, and one or more other computing devices. In one technique, the selective screen sharing may conceal a portion of the screen shared with or viewed by another computing device by providing a blocking element, such as a rectangle or logo, to conceal or replace the portion of the screen. In another technique, when a portion of the screen becomes deployed or visible in the screen view shared with another computing device, the screen sharing is automatically paused. In yet another embodiment of selective screen sharing, the present invention uses a layered windows technique to create and manage user interface elements that are not to be screen shared with another computing device. The techniques of the present invention may be used by online collaboration and web conferencing tools to prevent the screen sharing of selective portions of the screen with online meeting attendees or computing devices viewing the screen sharing.

In one aspect, the present invention relates to a method for selectively sharing screen data between a first computing device and a second computing device using an automatic pausing technique. The second computing device displays screen data of the first computing device. The method includes transmitting screen data displayed by the first computing device to a second computing device. The screen data includes a user interface element having a deployed state and an undeployed state. The undeployed state may include being minimized or not displayed. The method further includes detecting that the user interface element is in the deployed state, and in response to the detection, suspending transmission of screen data to the second computing device.

In one embodiment, the method of the present invention detects the user interface element transitioned from the deployed state to the undeployed state, and, in response to the detection, resuming transmission of screen data to the second computing device. The first computing device may display an indication that transmission of screen data to the second computing device is suspended.

In a further embodiment of the present invention, the user interface element may include any of the following: 1) a control panel, 2) a dialog, 3) a popup menu, 4) a tool tip, 5) a chat bubble, and 6) a system bubble. In other embodiments, the user interface element may include a private, a sensitive, or a confidential communication of a user.

In one embodiment, the method of the present invention may further include detecting a change to the first computing device's screen during the suspension of transmission of screen data. The method may queue a portion of screen data representing the screen change. After a predetermined time period, the method may discard the portion of screen data. In another embodiment, the method may further transmit the portion of screen data to the second computing device upon resuming transmission of screen data.

In yet another embodiment of the present invention, the screen of the first computing device may be represented as a plurality of tiles. The method of the present invention may detect a change to one of the tiles representing the screen, and may provide a data packet representing the change to the tile. The data packet may be transmitted to the second computing device. In one embodiment, the data packet is synchronized with the second computing device using a bandwidth-adaptive mechanism.

In one aspect, the present invention relates to a system for selectively sharing screen data between a first computing device and a second computing device using an automatic pausing technique. The second computing device displays screen data of the first computing device. The system includes a transmitter and a detector. The transmitter transmits screen data displayed by the first computing device to the second computing device. The screen data includes a user interface element having a deployed state and an undeployed state. The undeployed state may include the user interface element being minimized or not displayed. The detector detects the state of the user interface element. In response to the detector detecting the user interface element is in the deployed state, the transmitter suspends transmission of screen data to the second computing device.

In one embodiment of the system of the present invention, the detector detects the user interface element transitioning from the deployed state to the undeployed state. In response to the detector, the transmitter resumes transmission of screen data to the second computing device.

The system may provide an indicator displayed on the first computing device to identify the suspension of transmission of screen data to the second computing device.

In another embodiment of the present invention, the user interface element may include any of the following: 1) a control panel, 2) a dialog, 3) a popup menu, 4) a tool tip, 5) a chat bubble, and 6) a system bubble. In some embodiments, the user interface element may include a private, a sensitive, or a confidential communication of a user.

In a further embodiment, the system of the present invention may comprise a screen change detector detecting a screen change during the suspension of transmission of screen data. In other embodiments, the system of the present invention may include a queuing mechanism for queuing screen data. The queuing mechanism any queue a portion of screen data representing the screen change. After a predetermined time period, the queuing mechanism may discard the portion of screen data. In one embodiment, the transmitter transmits the portion of screen data to the second computing device upon resuming transmission of screen data.

In yet another embodiment of the present invention, the screen of the first computing device of the system may be represented as a plurality of tiles. The system may include a screen change detector detecting a change to a portion of the screen represented by one of the tiles.

The system may provide a data packet representing the change to the tile. The data packet may be transmitted to the second computing device. In one embodiment, the data packet is synchronized with the second computing device using a bandwidth-adaptive mechanism.

In another aspect, the present invention is related to a method for selectively sharing screen data between a first computing device and a second computing device using a first location and a second location. For example, the present invention may use a window layering technique for selective screen sharing. The method of the present invention includes storing to a first location a first portion of screen data for one or more screen elements displayed on the first computing device, and storing to a second location a second portion of screen data for a user interface element displayed on the first computing device. The method further transmits the first portion of screen data stored in the first location to the second computing device. The first location and second location may include a software component or a hardware component.

In one embodiment of the present invention, the user interface element is a layered window. In another embodiment, the user interface element is displayed using a layered windows application programming interface. In another embodiment, the user interface element may include any of the following: 1) a control panel, 2) a dialog, 3) a popup menu, 4) a tool tip, 5) a chat bubble, and 6) a system bubble. In some embodiments, the user interface element may include a private, a sensitive, or a confidential communication of a user.

In an additional embodiment, the method of the present invention represents the screen of the first computing device as tiles. The method detects a change to a screen element of a first tile and provides a data packet representing the change to the first tile. The method further includes synchronizing the data packet with the second computing device using a bandwidth-adaptive mechanism.

In one aspect, the present invention is related to a system for selectively sharing screen data between a first computing device and a second computing device using a first location and second location for storing screen data. The system includes a first location for storing a first portion of screen data for one or more screen elements displayed on the first computing device, and a second location for storing a second portion of screen data for a user interface element displayed on the first computing device. The first location and second location may include a software component or a hardware component. The system also includes a transmitter for transmitting the first portion of screen data stored in the first location to the second computing device.

In one embodiment of the present invention, the user interface element is a layered window. In another embodiment, the user interface element is displayed using a layered windows application programming interface. In another embodiment, the user interface element may include any of the following: 1) a control panel, 2) a dialog, 3) a popup menu, 4) a tool tip, 5) a chat bubble, and 6) a system bubble. In some embodiments, the user interface element may include a private, a sensitive, or a confidential communication of a user.

In one embodiment of the present invention, the first portion of screen data comprises multiple tiles representing the one or more screen elements. The system may also include a detector to detect a change to a screen element of a first tile of the multiple tiles. In further embodiments, the system may also include a mechanism to provide a data packet to the transmitter. The data packet may include a representation of the change to the first tile. In some embodiments, the transmitter may synchronize the data packet with the second computing device using a bandwidth-adaptive mechanism.

In another aspect, the present invention relates to a method of using a blocking element for selectively sharing screen data between a first computing device and a second computing device. The method includes transmitting screen data displayed by the first computing device to a second computing device, and displaying a first user interface element on the first computing device. In response to displaying the first user interface element, the present invention provides in a portion of screen data corresponding to the first user interface element screen data representing a second user interface element to be displayed on the second computing device, and transmits the portion of screen data to the second computing device. The second user interface element may include a 1) block, a 2) picture, or 3) a logo.

In one embodiment, the method of the present invention displays the portion of screen data having the second user interface element on the second computing device. In another embodiment, the first user interface element may include any of the following: 1) a control panel, 2) a dialog, 3) a popup menu, 4) a tool tip, 5) a chat bubble, and 6) a system bubble. In some embodiments, the first user interface element may include a private, a sensitive, or a confidential communication of a user.

In yet another aspect, the present invention relates to a system of using a blocking element for selectively sharing screen data between a first computing device and a second computing device. The system includes a transmitter for transmitting screen data displayed by a first computing device to a second computing device, and a display of the first computing device for displaying a first user interface element. The system also include a mechanism for providing screen data to the transmitter. In response to displaying the first user interface element on the display, the mechanism provides in a portion of screen data corresponding to the first user interface element screen data representing a second user interface element to be displayed on the second computing device. The transmitter transmits the portion of screen data to the second computing device for screen sharing. The second user interface element may include a 1) block, a 2) picture, or 3) a logo.

In one embodiment, the second computing device of the system of the present invention displays the portion of screen data having the second user interface element. In another embodiment, the first user interface element may include any of the following: 1) a control panel, 2) a dialog, 3) a popup menu, 4) a tool tip, 5) a chat bubble, and 6) a system bubble. In some embodiments, the first user interface element may include a private, a sensitive, or a confidential communication of a user.

The details of various embodiments of the invention are set forth in the accompanying drawings and the description below.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a block diagram of an illustrative embodiment of the present invention providing a networked system having multiple consumer nodes in communication with a source node;

FIGS. 2A and 2B are block diagrams depicting illustrative embodiments of a computing device useful in practicing an embodiment of the present invention;

FIG. 3 is a block diagram depicting an illustrative embodiment of a networked screen sharing system for practicing an embodiment of the present invention;

FIG. 4A is a diagrammatic view of a presenter's shared screen and an attendee's shared screen view in practicing an illustrative embodiment of the concealing technique of the present invention;

FIG. 4B is a flow diagram of steps performed in conjunction with FIG. 4A in practicing an illustrative embodiment of the concealing technique of the present invention;

FIG. 4C is an illustrative example of FIG. 4A in practicing an illustrative embodiment of the concealing technique of the present invention;

FIGS. 5A, 5B, 5C, and 5D are diagrammatic views of a presenter's shared screen and an attendee's shared screen view in practicing an illustrative embodiment of the automatic pausing technique of the present invention;

FIG. 5E is a flow diagram of steps performed in conjunction with FIGS. 5A-5D in practicing an illustrative embodiment of the automatic pausing technique of the present invention;

FIGS. 5F-5I are illustrative examples of FIGS. 5A-5D in practicing an illustrative embodiment of the automatic pausing technique of the present invention;

FIG. 6A is a diagrammatic view of a presenter's shared screen and an attendee's shared screen view in practicing an illustrative embodiment of the window layering technique of the present invention;

FIG. 6B is a block diagram depicting an illustrative environment for practicing an embodiment of the window layering technique of the present invention;

FIG. 6C is a flow diagram of steps performed in conjunction with FIGS. 6A and 6B in practicing an illustrative embodiment of the window layering technique of the present invention;

FIG. 6D is an illustrative example of FIG. 6A in practicing an illustrative embodiment of the window layering technique of the present invention;

FIG. 7A is a block diagram depicting another illustrative embodiment of a networked system having a plurality of consumer nodes in communication with a source node for practicing an embodiment of the present invention;

FIG. 7B is a block diagram depicting packet flow in one embodiment of an architecture for synchronizing data sets between a source node and a plurality of consumer nodes in a bandwidth-adaptive manner;

FIG. 8 is a diagrammatic view of a system for sharing screen data; and

FIG. 9 is a diagrammatic representation of a data structure useful in a system for sharing graphical screen data.

### DESCRIPTION

Certain illustrative embodiments of the present invention are described below. It is, however, expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not expressly made herein, without departing from the spirit and scope of the invention.

The illustrative embodiments of the present invention provide screen sharing techniques to selectively share portions of the screen between one computing device, such as a source node, and another computing device, such as a consumer node. The source computing device, such as the computer of a presenter in an online meeting, may transmit screen data to a consumer computing device, such as the computer of an attendee of the online meeting. The consumer or attendee computing device uses the screen data to display the screen of the source or presenter's computing device. The illustrative embodiments are generally described in connection with the following techniques of the present invention: 1) a concealing technique, 2) an automatic pausing technique, and 3) a layered windows technique. Each of the techniques provides a mechanism for not sharing a selective portion of the presenter's screen during screen sharing. In one embodiment, the techniques of the present invention may be used in an online conferencing or meeting environment to keep user interface elements of the presenter's screen hidden or private from one or more meeting attendees.

In the illustrative embodiment of the concealing or blocking technique, the present invention may conceal a user interface element of the screen shared with a consumer node by providing a blocking element, such as a rectangle or logo, to replace the representation of the user interface element in the screen data transmitted to the consumer node. The user interface element may be a user interface element of the online meeting tool that is desired not to be viewed or shared via the screen sharing. For example, a control panel of the online meeting tool may transition between a minimized state and a deployed state as the presenter interacts with the control panel in managing the online meeting. In another example, a user interface form such as a dialog or popup message from the online meeting tool may become displayed during screen sharing based on the presenter's user interface interactions. The concealing technique of the present invention detects the deploying or displaying of the user interface element during screen sharing. Instead of providing screen data representing the deployed or displayed user interface element, the concealing technique provides a blocking element in the screen data transmitted to the consumer mode. This blocking element may be a logo or rectangle or any other picture, or graphic, which replaces the deployed or displayed user interface element in the screen data. The consumer node receives the screen data with the blocking element and displays the blocking element in the area of the shared screen where the user interface element of the source node would be displayed. As such, the viewer or attendee on the consumer node sees the blocking element instead of the user interface element.

In the illustrative embodiment of the automatic pausing technique, the present invention automatically pauses the transmission of screen data to the consumer node upon detection of the displaying or deploying of a user interface element on the presenter's screen that is to be excluded from screen sharing. During screen sharing, the source node transmits screen data to the consumer node as the screen of the presenter changes. The present invention detects that the presenter's screen has changed via the deploying (maximizing) of a minimized user interface element or the displaying of a new user interface element on the screen. It may be desired that the user interface element be excluded from screen sharing. The automatic pausing technique of the present invention automatically suspends the transmission of the screen data to the consumer node upon detection that such a user interface element is deployed or displayed. During suspension, the consumer node may display the last copy of screen data from the source node. The transmission of screen data is resumed when the present invention detects the presenter's screen no longer displays a user interface element that is desired to be excluded from the screen share. The present invention may provide an indicator that the screen sharing is automatically paused so that the presenter is aware the consumer node is not receiving screen data. Additionally, the source node may queue and keep track of screen changes during the suspension of transmission of screen data in order to transmit the appropriate screen data changes when transmission resumes.

In the illustrative embodiment of the layered windows technique, the systems and methods of the present invention stores screen data of user interface elements of the presenter's screen to be screen shared in a first location and stores screen data of user interface elements of the presenter's screen not to be screen shared in a second location. For example, the screen data of a user interface element of the online meeting tool, such as the control panel or a dialog box, may be displayed on the presenter's screen and stored in the second location. The present invention transmits screen data from the first location to the consumer node. Thus, the consumer node does not receive the screen data for the user interface element stored in the second location although displayed on the presenter's screen. In one embodiment, layered windows are used to provide the user interface element that is to be selectively excluded from the screen data. The screen capturing mechanism of the present invention may not capture or may otherwise ignore any layered windows and therefore provide screen data only having non-layered windows. Using the layered windows technique, screen data is stored and transmitted only for the portions of the screen desired to be screen shared.

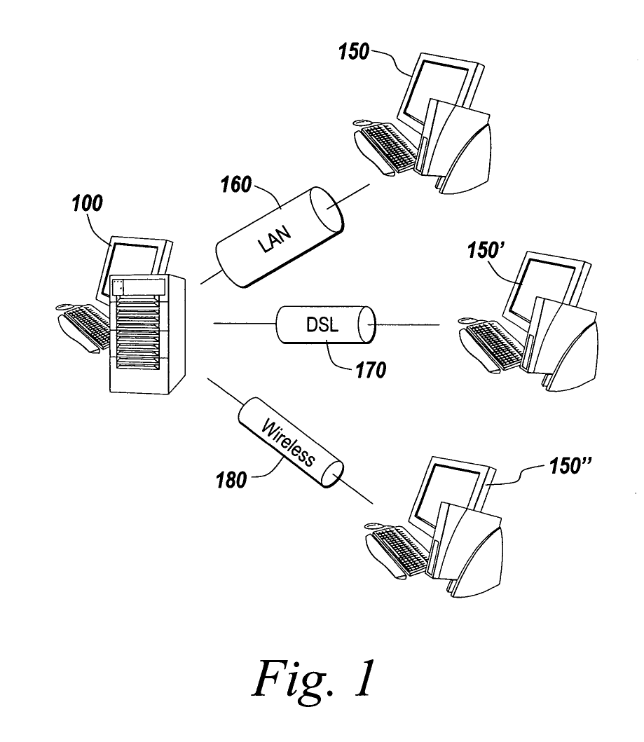

FIG. 1 illustrates a networked system for practicing an embodiment of the present invention. In brief overview, a source node 100 is in communication with a number of consumer nodes 150, 150′, 150″. For example and as will be discussed in further detail below, the source node 100 may be the computing device of a presenter sharing screen data with one or more users of the consumer nodes 150, 150′, 150″, such as during an online conference or meeting. As illustrated in FIG. 1, the consumer nodes 150, 150′, 150″ may communicate with the source node 100 via networks of differing bandwidths. Consumer node 150 may communicate with the source node 100 via a high-bandwidth network 160, such as a local area network (LAN). Consumer node 150″ may communicate with the source node 100 via a low-bandwidth network 180, such as a wireless network. Consumer node 150′ may communicate with the source node 100 via a network 170 having bandwidth between the low-bandwidth network 180 and the high-bandwidth network 160, such as a Digital Subscriber Line (DSL) connection. Although only one source node 100 and three consumer nodes 150, 150′, 150″ are depicted in the embodiment shown in FIG. 1, the system may provide multiple instances of any or each of the source nodes and consumer nodes. For example, in one embodiment, the system may include multiple, logically-grouped source nodes 100, each of which may be available to provide data to a consumer node 150, 150′, 150″. In these embodiments, the logical group of source nodes 100 may be referred to as a “server farm” or “content farm.” In other embodiments, the source node 100 may include a multi-user server having a virtual frame buffer, i.e., a presentation server.

The network connections 160, 170, 180 between the consumer nodes 150, 150′, 150″ and the source node 100 may be local area networks (LAN), metropolitan area networks (MAN), or a wide area network (WAN), such as the Internet. The source node 100 and the consumer nodes 150, 150′, 150″ may connect to the networks 160, 170, 180 through a variety of connections including standard telephone lines, LAN or WAN links (e.g., T1, T3, 56 kb, X.25, SNA, DECNET), broadband connections (ISDN, Frame Relay, ATM, Gigabit Ethernet, Ethernet-over-SONET), and wireless connections or any combination thereof. Connections can be established using a variety of communication protocols (e.g., TCP/IP, IPX, SPX, NetBIOS, Ethernet, ARCNET, Fiber Distributed Data Interface (FDDI), RS232, IEEE 802.11, IEEE 802.11a, IEEE 802.11b, IEEE 802.11 g, and direct asynchronous connections). Although shown in FIG. 1 as separate networks, networks 160, 170, 180 may be combined in a single physical network or may further include additional networks.

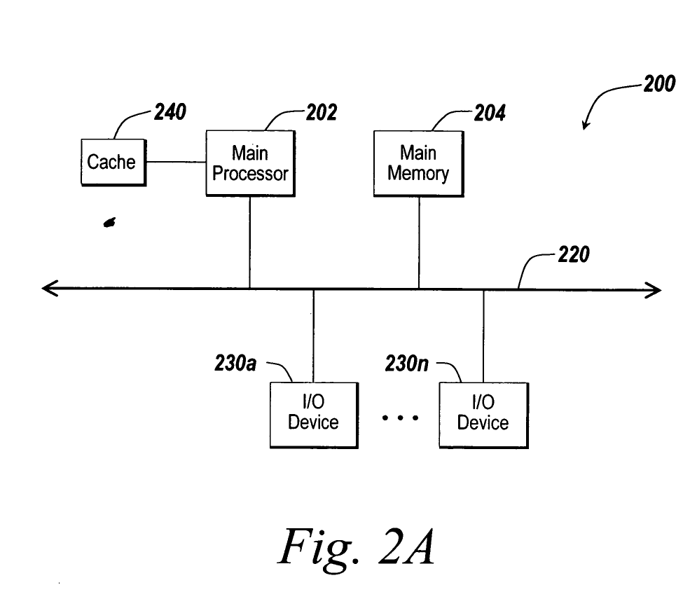

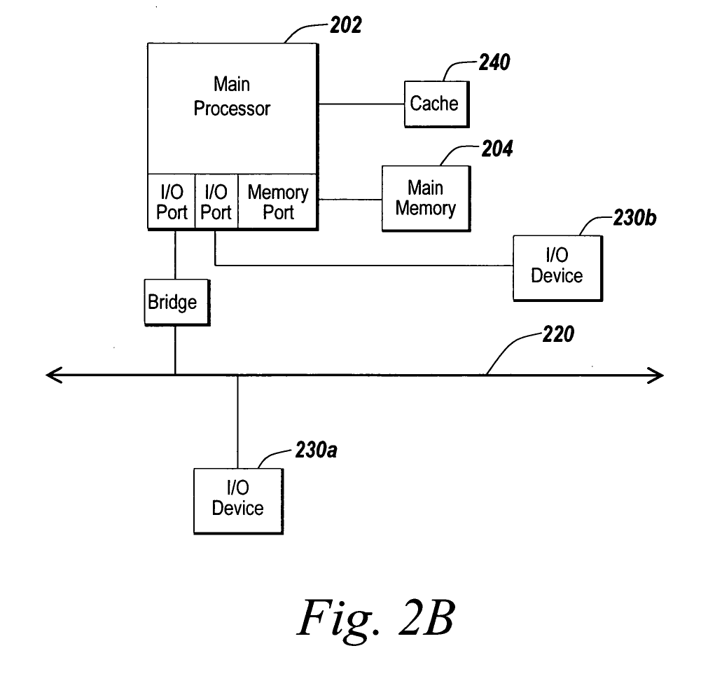

The source node 100 and the consumer nodes 150, 150′, 150″ may be provided as any type and/or form of computing device such as a personal computer or computer server of the sort manufactured by the Hewlett-Packard Corporation of Palo Alto, Calif. or the Dell Corporation of Round Rock, Tex. FIGS. 2A and 2B depict block diagrams of a typical computing device 200 useful as the source node 100 and the consumer nodes 150, 150′, 150″. As shown in FIGS. 2A and 2B, each computing device 200 includes a central processing unit 202, and a main memory unit 204. Each computing device 200 may also include other optional elements, such as one or more input/output devices 230a-230n (generally referred to using reference numeral 230), and a cache memory 240 in communication with the central processing unit 202. The input/output devices 230 of computing device 200 may include a visual display device, a keyboard and/or a pointing device, such as a mouse, or a laser or optical pointer.

The central processing unit 202 is any logic circuitry that responds to and processes instructions fetched from the main memory unit 204. In some embodiments, the central processing unit is provided by a microprocessor unit, such as: the 8088, the 80286, the 80386, the 80486, the Pentium, Pentium Pro, the Pentium II, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, the MPC7457 processor, all of which are manufactured by Motorola Corporation of Schaumburg, Ill.; the Crusoe TM5800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS 64 II, the P2SC, the POWER3, the RS64 III, the POWER3-II, the RS 64 IV, the POWER4, the POWER4+, the POWER5, or the POWER6 processor, all of which are manufactured by International Business Machines of White Plains, N.Y.; or the AMD Opteron, the AMD Athalon 64 FX, the AMD Athalon, or the AMD Duron processor, manufactured by Advanced Micro Devices of Sunnyvale, Calif. The computing device 200 may be based on any of the above described processors, or any other processor capable of performing the operations described herein.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 204 may be based on any of the above described memory chips, or any other type and/or form of memory capable of performing the operations described herein.

In the embodiment shown in FIG. 2A, the processor 202 communicates with main memory 204 via a system bus 220 (described in more detail below). FIG. 2B depicts an embodiment of a computing device 200 in which the processor communicates directly with main memory 204 via a memory port. For example, in FIG. 2B the main memory 204 may be DRDRAM. Additionally, FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 220. Cache memory 240 may have a faster response time than main memory 204 and may be provided by SRAM, BSRAM, or EDRAM.

In the embodiment shown in FIG. 2A, the processor 202 communicates with various I/O devices 230 via a local system bus 220. Various buses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is an video display, the processor 202 may use an Advanced Graphics Port (AGP) to communicate with the display. FIG. 2B depicts an embodiment of a computing device 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, microphones, and drawing tablets or any type and/or form of haptic or sensory feedback device. Output devices include video displays, speakers, inkjet printers, laser printers, and dye-sublimation printers. An I/O device may also provide mass storage for the computing device 200 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif. The storage device may comprise one or more hard disk drives or redundant arrays of independent disks, for storing an operating system and other related software, and for storing application software programs such as any program related to the screen sharing techniques of the present invention as described herein.

The I/O device 230 of computing device 200 may support any suitable installation device such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any software related to screen sharing techniques of the present invention. Optionally, any of the installation devices may also be used as the storage device. Additionally, the operating system and any software of the present invention can be run from a bootable medium, for example, a bootable CD, such as KNOPPIX®, a bootable CD for GNU/Linux that is available as a GNU/Linux distribution from knoppix.net.

In further embodiments, an I/O device 230 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

Computing devices of the sort depicted in FIGS. 2A and 2B typically operate under the control of operating systems, which control scheduling of tasks and access to system resources. The computing device 200 can be running any operating system such as any of the versions of the Microsoft® Windows operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device 200 and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, Java or Unix, among others.

In other embodiments, the computing device 200 may have different processors, operating systems, and input devices consistent with the device. For example, in one embodiment the computer 100 is a Zire 71 personal digital assistant manufactured by Palm, Inc. In this embodiment, the Zire 71 operated under the control of the PalmOS operating system and includes a stylus input device as well as a five-way navigator device.

In some embodiments the consumer node 150, 150′, 150″ is a mobile device, such as a JAVA-enabled cellular telephone or personal digital assistant (PDA), such as the i50sx, i55sr, i58sr, i85s, i88s, i90c, i95cl, or the im11000, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In other embodiments, the consumer node 150, 150′, 1450″ may be a personal digital assistant (PDA), such as the Tungsten W, the VII, the VIIx, the i705, or a combination PDA/telephone device such as the Treo 180, Treo 270 or Treo 600, all of which are manufactured by palmOne, Inc. of Milpitas, Calif. In these embodiments, the consumer nodes 150, 150′, 150″ may connect to the source node 100 using any one of a number of well-known protocols from the GSM or CDMA families, such as W-CDMA that support wireless communication services. For example, in one embodiment, the protocol may comprise the underlying protocol supporting i-Mode and mMode wireless communication services, such as those offered by NTT DoCoMo, Inc. of Tokyo, Japan.

Furthermore, the computing device 200 may include an I/O device 230 comprising a network interface to interface to a Local Area Network (LAN), Metropolitan Area Network (MAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface may comprise a built-in network adapter, network interface card, PCMCIA network card, card bus network adapter, wireless network adapter, USB network adapter, modem or any other device suitable for interfacing the computing device 200 to any type of network capable of communication and performing the operations described herein.

Moreover, as one ordinarily skilled in the art will recognize and appreciate, the computing device 200 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

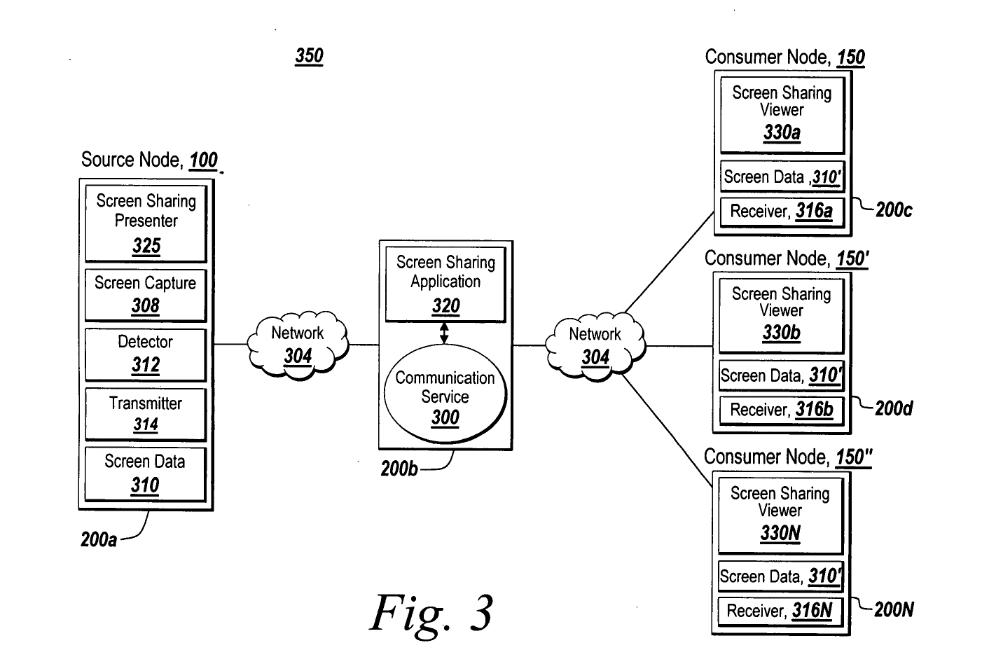

Referring now to FIG. 3, an illustrative environment 350 for practicing an embodiment of the present invention to provide screen sharing between a source node 150 and one or more consumer nodes 150, 150′, 150″ is depicted. In brief overview, the illustrative environment 350 may include a source node 100 on computing device 200a in communications with a communication service 300 of computing device 200b over network 304, which in turns communicates over network 304 with consumer nodes 150, 150′ and 150″ on computing device 200c, 200d, and 200e respectively. The network 204 may be any type of network, such as a LAN, MAN, or WAN, and may include one or more connections of varying bandwidth or transmission speeds. The communication service 300 may provide communication services to transmit and/or exchange data packets and any other information between the source node 100 and any or all of the consumer nodes 150, 150′, 150″, such as screen data 310 from the screen data presenter 325 to a screen sharing viewer 330a-330n. In some embodiments as will be described in further detail below, the communication service 300 may provide a bandwidth adaptive mechanism to handle the transmission of data packets, such as data packets comprising screen data 310, for different bandwidth connections to the communication service 300. Although the communication service 300 is illustrated on computing device 200b, it may be part of the computing device 200a or any other computing device 200b-200n on the network 304.

In one aspect, the present invention is related to screen sharing between a first computing device 200a and a second computing device 200c-220n as depicted in the illustrative environment 350. A screen sharing application 320 may be accessible via the network 304 to provide any type and/or form screen sharing such as, for example, screen sharing for online meetings or web conferencing. In one embodiment, the screen sharing application 320 comprises an application or a service provided via a web-site and may be accessible via the Internet, such any type and/or form of online meeting tool. For example, the screen sharing application 320 may comprise any of the products, software, tools or services provided by GoToMeeting.com provided by Citrix, Inc. of Ft. Lauderdale, Fla., WebEx.com provided by WebEx, Inc. of Santa Clara, Calif., or LiveMeeting.com provided by Microsoft Corporation of Redmond, Wash. In some embodiments, the screen sharing application 320 provides any suitable means and/or mechanisms for setting up and establishing an online meeting between remotely located people and/or computing devices. One ordinarily skilled in the art will recognize and appreciate the different types and forms and corresponding functionality of online meeting and web conferencing that the screen sharing application 310 may provide.

In other embodiments, the screen sharing application 320 provides any suitable means and/or mechanisms for any type of session between computing devices for screen sharing so that a second computing device may display screen data from a first computing device. In yet a further embodiment, the screen sharing application 320 may provide any suitable means and/or mechanisms for providing software of any type or form to the source node 100 to share screen data 310 with another computing device and/or transmit screen data 310 via the communication service 300. Likewise, the screen sharing application 320 may provide any suitable means and/or mechanisms for providing software of any type or form to the consumer node 100 to view screen data 310 received from another computing device and/or receive screen data 310′ via the communication service 300. One ordinarily skilled in the art will recognize and appreciate that the screen sharing application 320 may provide any type of software and perform any type of operations to facilitate, coordinate and/or manage in cooperation with the communication service 300 or otherwise, screen sharing between a source node 100 and one or more consumer nodes 150, 150′, 150″.

As illustrated in FIG. 3, the source node 100 may comprise a screen sharing presenter 325 application for establishing, coordinating, controlling and/or managing any activities of capturing screen data 310 and sharing screen data 310 on computing device 200a or by the user, i.e., presenter, of computing device 200a. The screen sharing presenter 325 may comprise any type and/or form of one or more user interface elements to start, stop, pause/suspend, resume/continue, or otherwise manipulate the screen sharing activity between the source node 100 and a consumer node 150-150″. For example, the screen sharing presenter 325 may include a control dialog or task bar that is minimized when not deployed and maximized when deployed. In some embodiments, the screen sharing presenter 325 allows a user to configure or specify the portion of the visible screen area of the display 230 of the computing device 200a for which to share or provide screen data 310. In one embodiment, the screen sharing presenter 325 may be configured to screen share the entire desktop area or the entire screen view displayed on the display 230. In other embodiments, the screen sharing presenter 325 may be configured to screen share only the portions of the screen displaying a particular application, such as Microsoft Word, PowerPoint or other Microsoft Office application manufactured by the Microsoft Corporation of Redmond, Wash. The screen sharing presenter 325 may be configured to screen share all or any portion of the viewable screen area of the display 230 of computing device 200a, and may also be configured to handle multiple display devices 230 and/or virtual display areas or virtual desktops.

Still referring to FIG. 3, a screen capture mechanism 308 may be provided and used on the source node 100a to capture and provide screen data 310 by any suitable means and/or mechanisms. The screen capture mechanism 308 may obtain a representation of the screen, image of the screen, or any screen elements in any type of form, and convert, translate, or process the representation into screen data 310. In some embodiments, the screen capture mechanism 308 may use any application programming interface (API), such as an operating system API, to obtain and process information to provide the screen data 310. In some embodiments as will be discussed in further detail below, the screen capturing mechanism 308 may represent the screen as tiles. In these embodiments, the screen data 310 may comprise the tile representation of the screen. The screen data 310 may comprise any suitable type and/or form of representation of the screen, and may include portions of the screen to be screen shared as well as other portions not to be screen shared. In some embodiments, the screen data 310 may provide a pixel or bit-image representation of the screen. One ordinarily skilled in the art will appreciate and recognize the various forms and types of screen capturing mechanisms and resulting screen data that may be used in practicing the operations of the present invention described herein.

Also, the source node 100 of FIG. 3 may include a detector 312 that comprises any suitable mechanism and/or means for determining if there has been a change to the screen. For example, the detector 312 may detect if a new user interface element has been displayed, a current user interface element has been removed or undisplayed, or has been maximized or minimized, or otherwise has changed position on the screen. In one embodiment, the detector 312 detects if there has been any change in the pixels or in any portion of an image of the screen. For example, the detector 312 may detect if there has been in a change in the screen causing a change to the one or more tiles representing the screen. In some embodiments, the detector 312 may be included in or integrated with the screen capturing mechanism 308. In other embodiments, the detector 312 may provide any changes to the screen data 310 corresponding to the changes on the screen it has detected.

The source node 100 may also include a transmitter 314 for transmitting data and information to the one or more consumer nodes 150, 150′, 150″. The screen sharing presenter 325, the screen capturing mechanism 308, and/or the detector 308 may provide screen data 310 to the transmitter 314 to transmit. In these embodiments, the transmitter 314 may process the screen data 310 to provide data packets or any other form of network communication unit for transmission to a consumer node 150. In other embodiments, the screen sharing presenter 325, the screen capturing mechanism 308, and/or the detector 308 may provide data packets representing the screen data 310 to the transmitter 314. Additionally, the transmitter 314 may also provide other network communication related processing such as compression and/or encryption of data packets and/or the screen data 310. In some embodiments, the transmitter 314 communicates with the communication service 300, while in other embodiments, the transmitter may communicate directly to a consumer node 150-150″.

Referring still to FIG. 3, the consumer nodes 150-150″ may include a receiver 316a-316n for receiving any communications from either the communication service 300 or from a source node 100. The receiver 316a-316n may receive and process any screen data 310 provided by the source node 100 to form a copy of the screen data 310′ on the consumer node 310. In some embodiments, the screen data 310′ on the consumer node 150-150″ comprises a duplicate copy of the screen data 310 on the source node 100 or transmitted by the source node 100. In other embodiments, the screen data 310 provided by the source node 100 may be processed by the communication service 300, screen sharing application 320, or the receiver 316a-316n to form a different copy of screen data 310′ on the consumer node 100. In some cases, the screen data 310′ has been processed for suitable displaying on the resolution, type and/or form of display 230 of the computing device 200c-200n of the consumer node 150-150″.

One or more consumer nodes 150-150″ may comprise a screen sharing viewer 330a-330n for displaying the screen data 310′. The screen sharing viewer 330a-330n may provide any suitable means and/or mechanisms for displaying the screen data 310′ on the display 230 of the computing device 200c-220n of the respective consumer node 150-150″. The screen sharing viewer 330a-330n may be in communication with the receiver 316a-316n to obtain, process, and display the screen data 310′. For example, if the source node 100 is providing screen sharing of the desktop environment of the computing device 200a, the screen sharing viewer 330a-330n may provide for the display of a representation of the desktop environment via the screen data 310, 310′. The screen sharing viewer 330a-330n may also process the screen data 310′ to provide a suitable form of representation of the screen of the source node 100 on the display of the computing device 200c-200n of the consumer node 150-150″.

In addition, the source node 100 may have a receiver 316 for receiving communications from the communication service 300 and/or a consumer node 150-150″. In some embodiments, the transmitter 314 may include the receiver 316 or the functionality of the receiver 316. Likewise, each of the consumer nodes 150-150″ may also include a transmitter 314 separate from or as a part of the receiver 315 for transmitting communications to the communication service 300 of the source node 100. One ordinarily skilled in the art will recognize and appreciate the source node 100 and consumer nodes 150-150″ may communicate via a receiver and/or transmitter for receiving and sending network communications via the communication service 300 or directly to each other.

Furthermore, the network 304 and network connections may include any transmission medium between any of the computing devices 200a-220n, such as electrical wiring or cabling, fiber optics, electromagnetic radiation or via any other form of transmission medium capable of supporting the operations of the present invention described herein. The methods and systems of the present invention may also be embodied in the form of computer data signals, program code, or any other type of transmission that is transmitted over the transmission medium, or via any other form of transmission, which may be received, loaded into, and executed, or otherwise processed and used by a computing device 200a-200n to practice the operations of the present invention as described herein.

Additionally, the transmitter 314, receiver 316, and/or communication service 300, and any portion thereof, may include any suitable type and/or form of queuing mechanism for queuing any data packets or other communications communicated in any direction between the source node 100 and consumer node 150 and the communication service 150. For example, the queuing mechanism may comprise any suitable memory or storage location, and any data structures or instructions associated with establishing and maintaining a queue as known to those ordinarily skilled in the art. As the transmitter 314, receiver 316, and/or communication service 300 may communicate data packets representing screen data 310, the queuing mechanism may then be queuing the screen data 310 that has been provided for network communication. Furthermore, the detector 310 and/or screen capture mechanism 308 may also have any suitable type and/or form of queuing mechanism for queuing changes to the screen and/or changes to the screen data 310 prior to being provided for network communication. As such, in some embodiments, the management of a queue of screen data changes may occur prior to providing the screen data 310 to the transmitter 314 for transmission.

The communication service 300, screen sharing application 320, screen sharing presenter 325, screen sharing viewer 330a-330n, screen capture mechanism 308, detector 310, transmitter 314 and receiver 316 and any portion thereof, can comprise an application, module, service, computer program, software component, web service, web component, web page, library, function, script, interpreted language, or any other type and/or form of executable instruction which is designed to and capable of executing the functionality of the present invention as described herein. Furthermore, any of the above-mentioned elements of the present invention, and any portion thereof, may be implemented in or comprise any type and/or form of hardware component or system, and may comprise any combination of software and hardware.

Although the screen sharing environment 350 of FIG. 3 is illustrated with a single source node 100 in communication with one or more consumer nodes 150-150″, those ordinarily skilled in the art will recognize and appreciate the environment may support and provide screen sharing between multiple source nodes and multiple consumer nodes via one or more communication services. Additionally, some of the source nodes may be in communication with the same consumer node(s) and/or communication services, and vice-versa

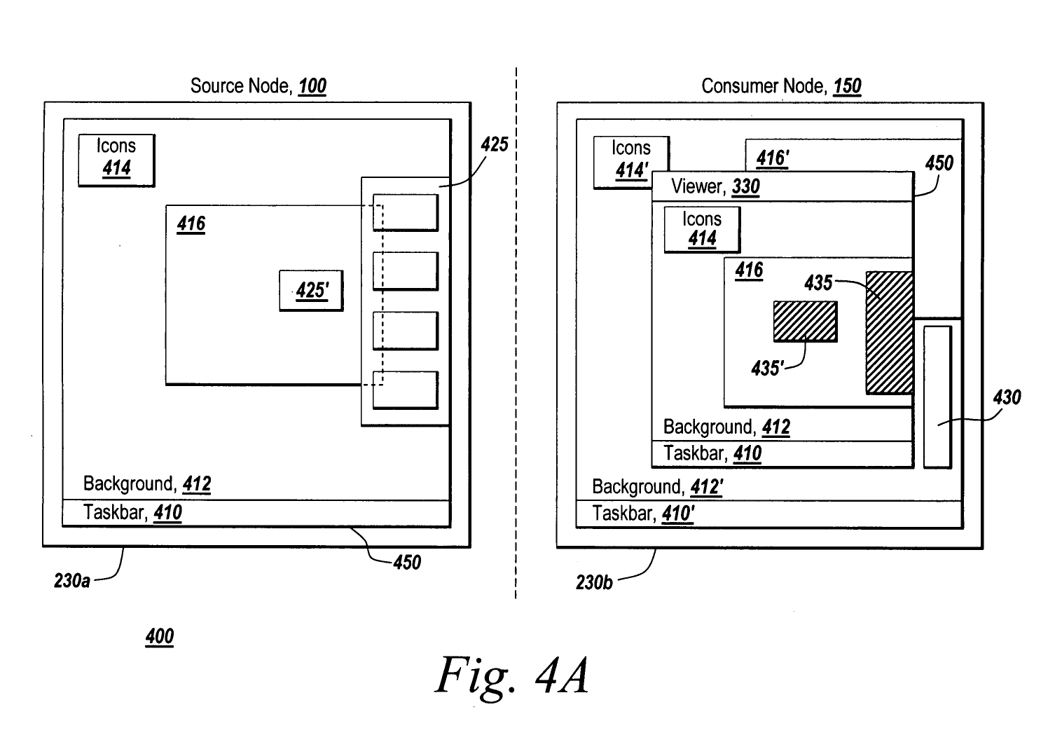

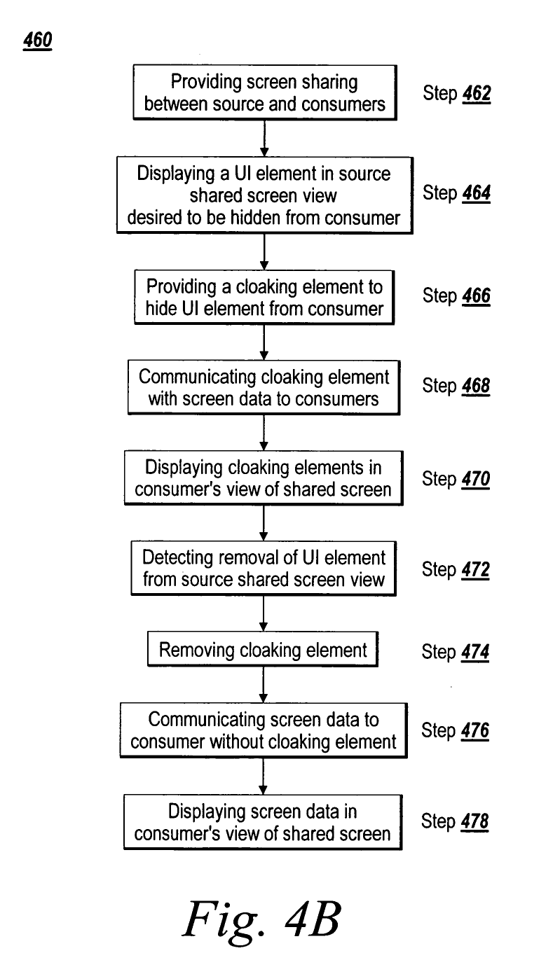

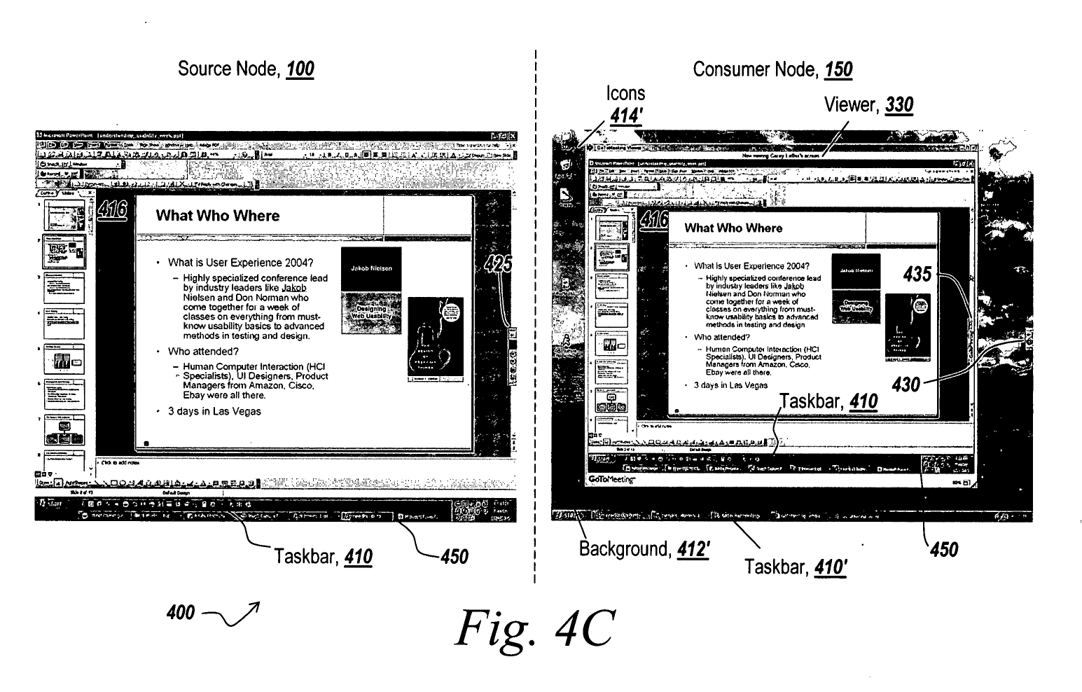

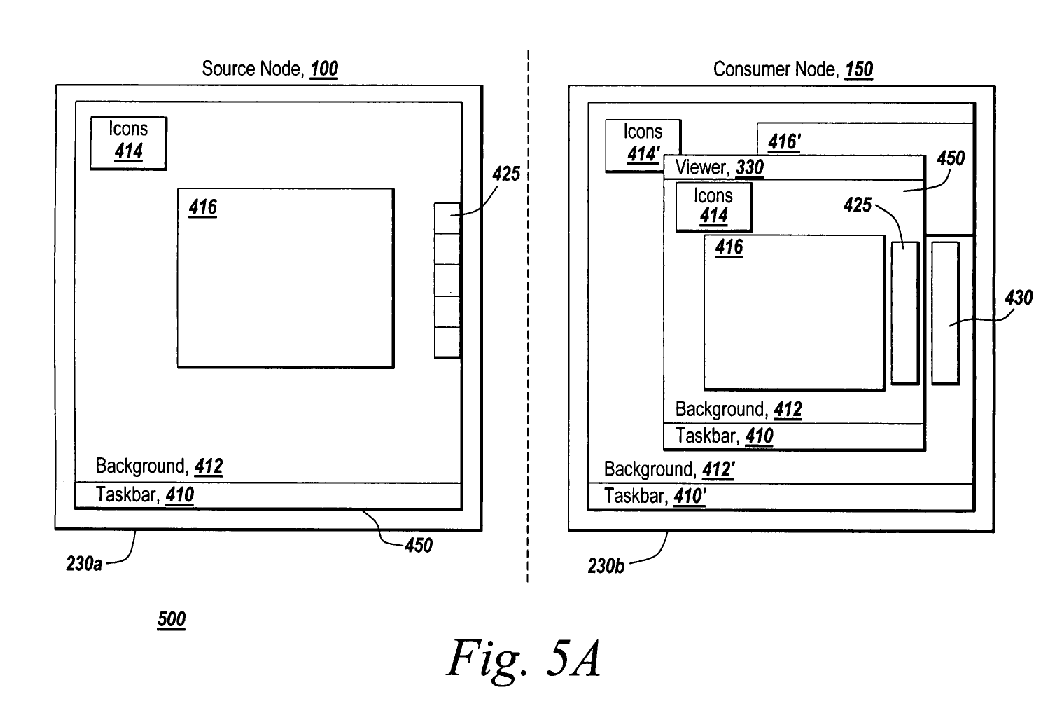

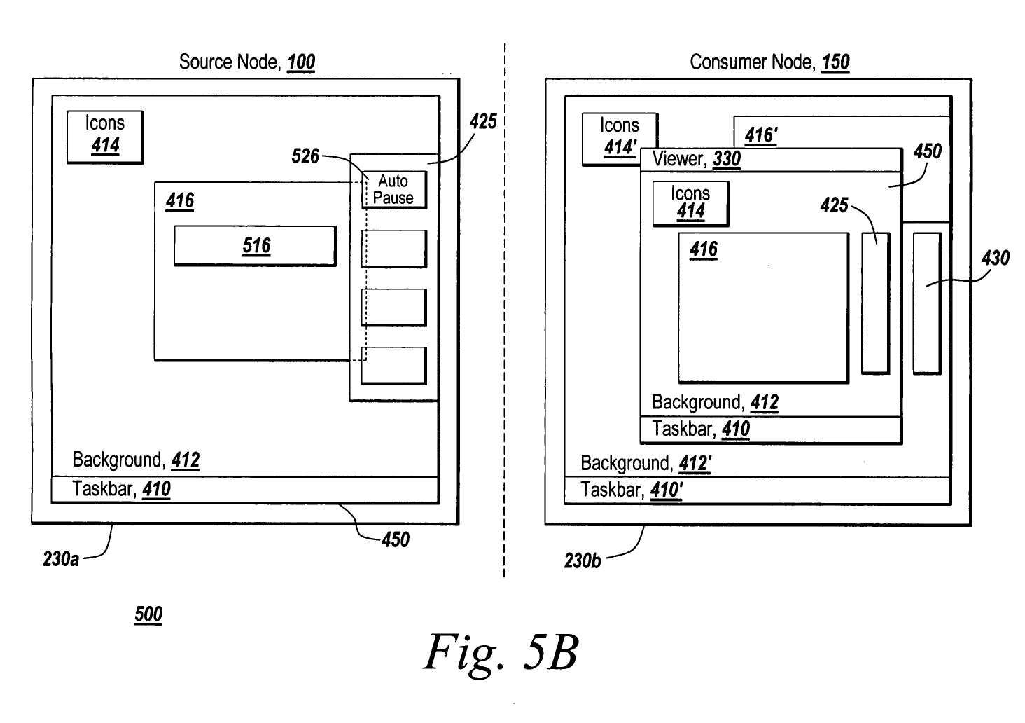

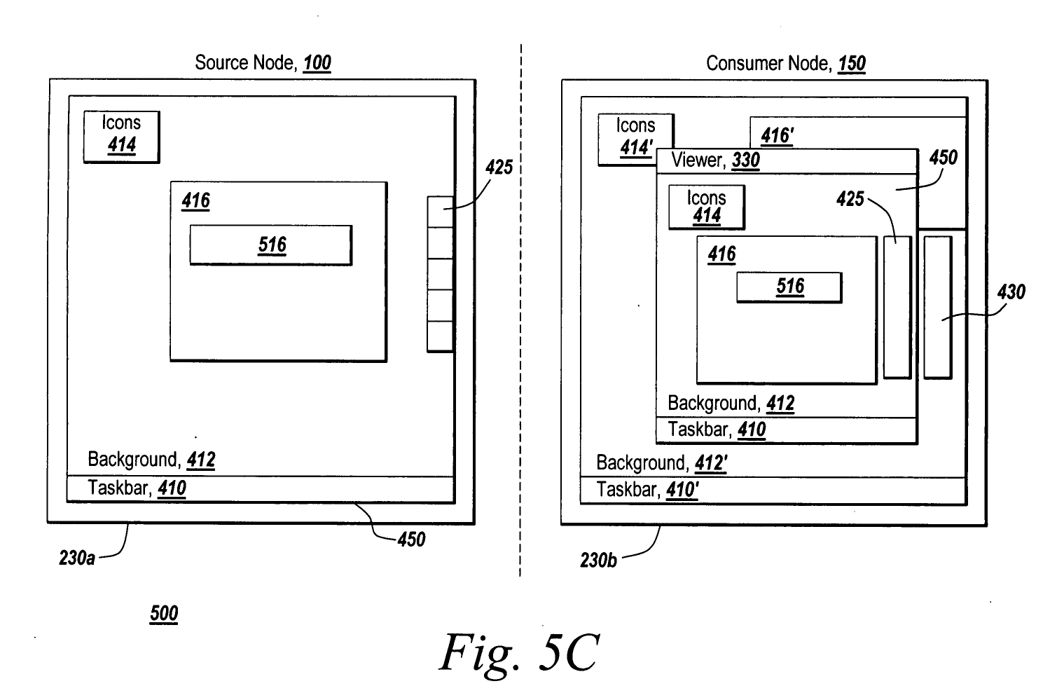

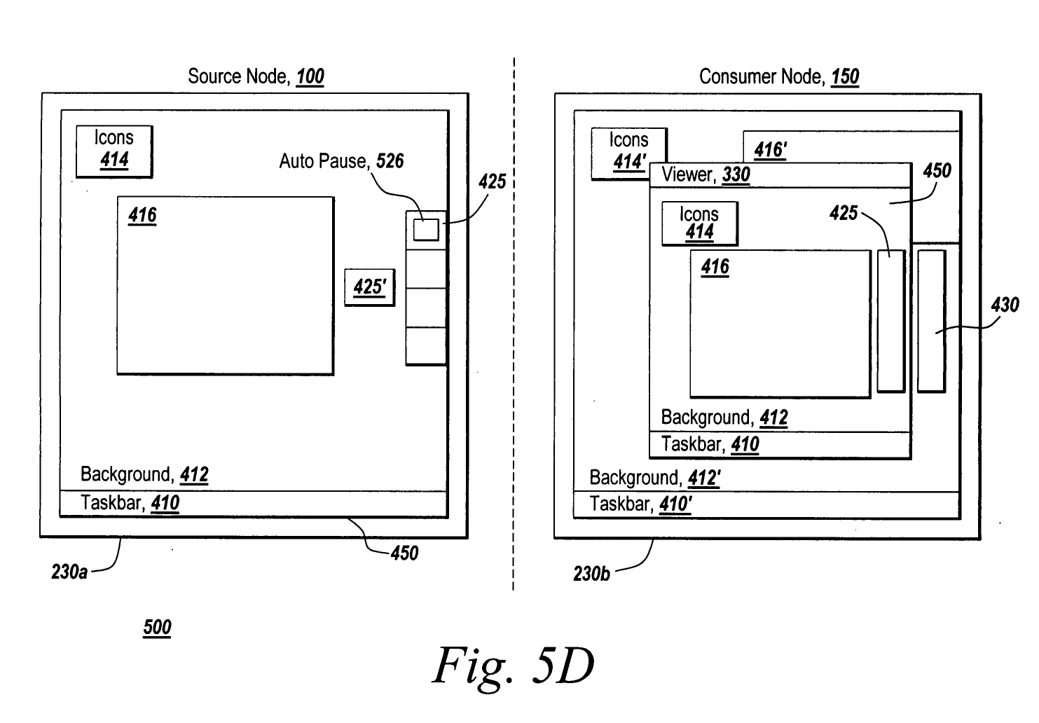

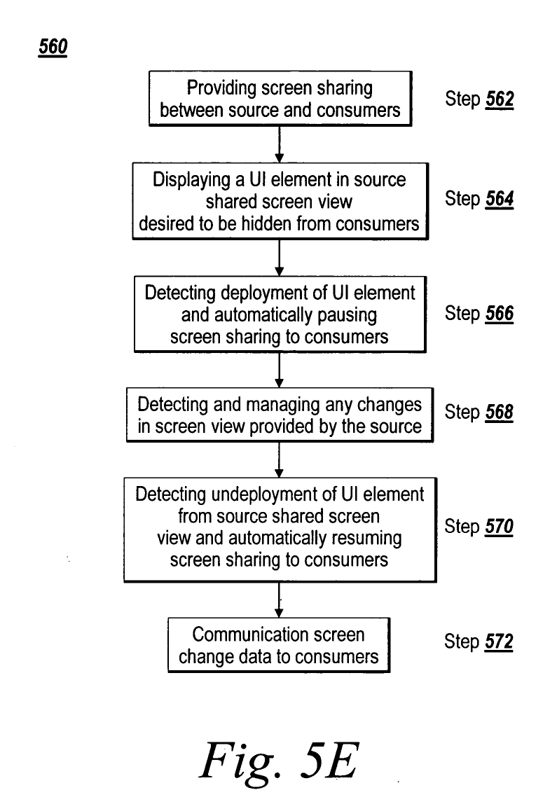

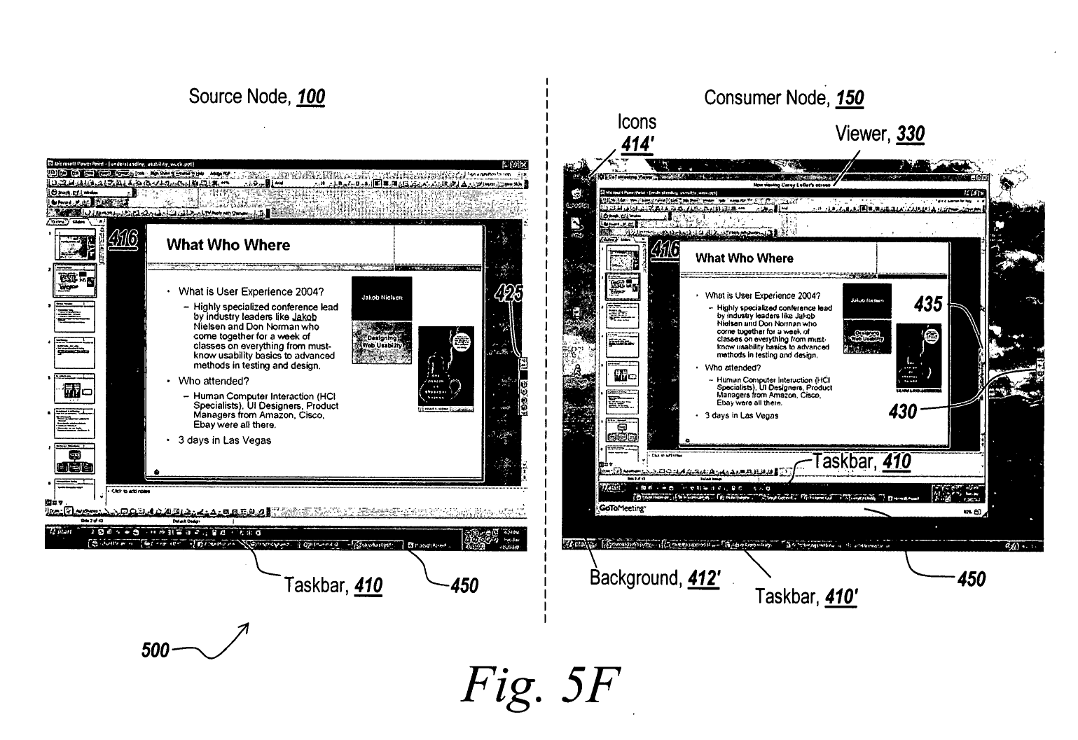

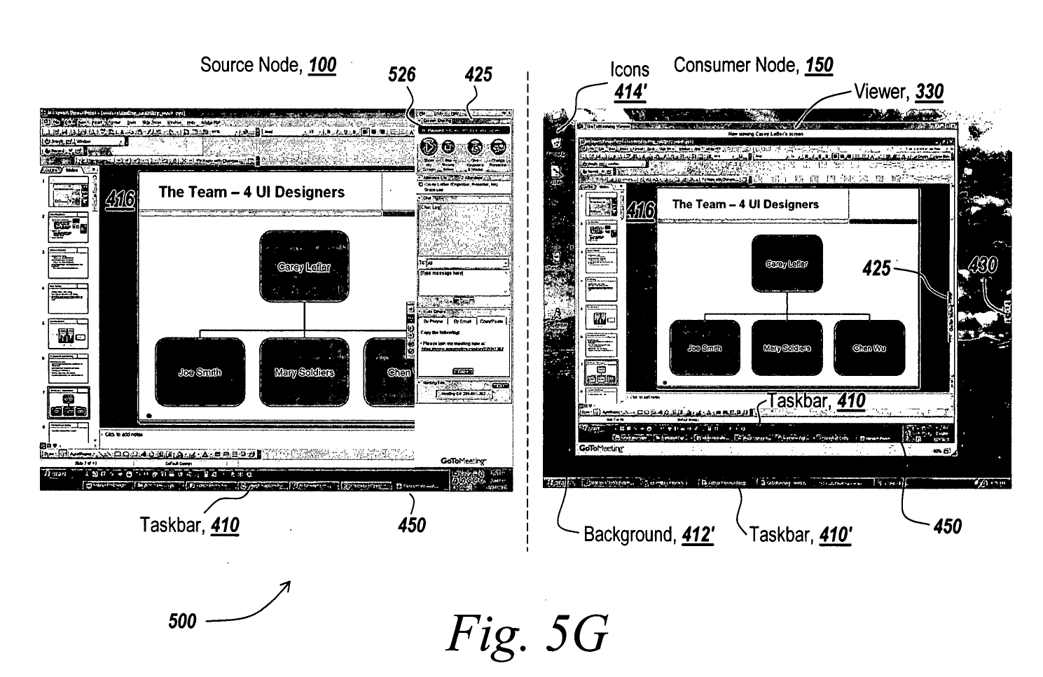

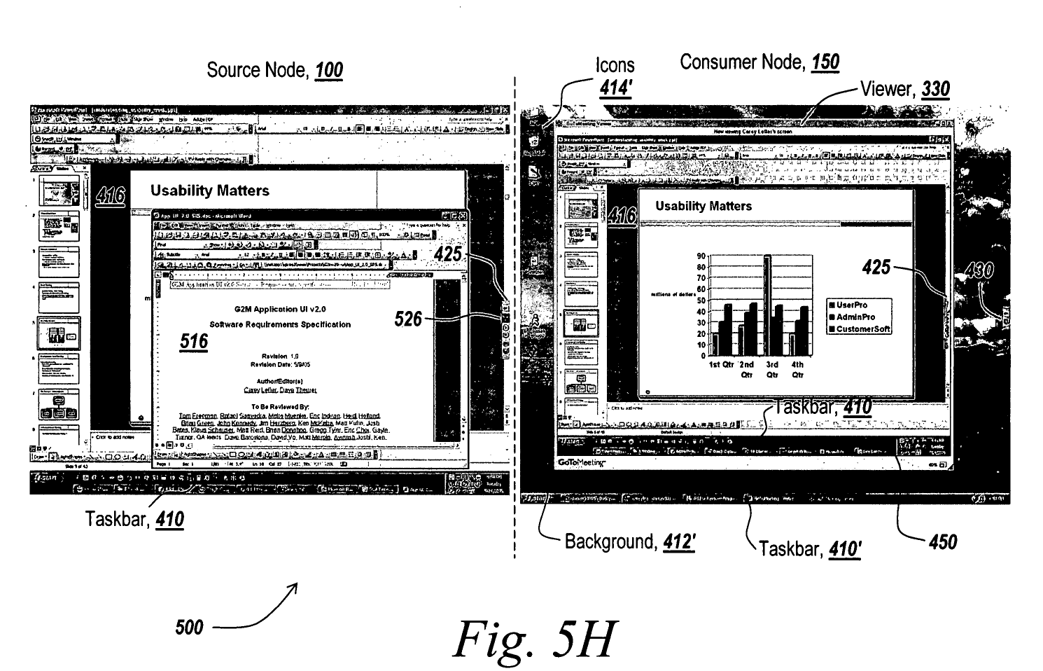

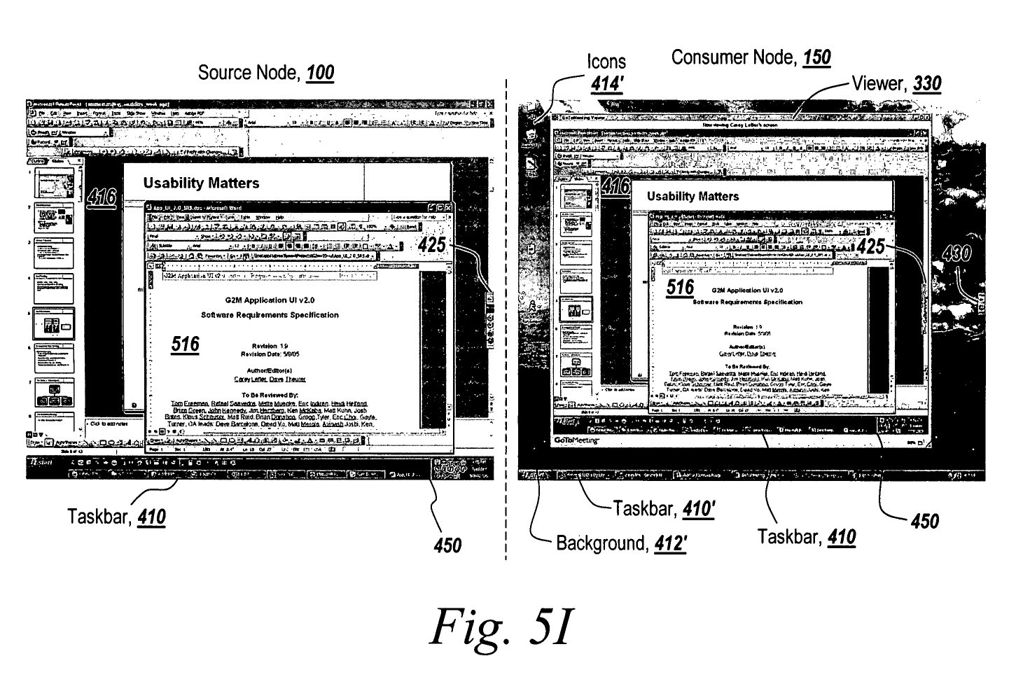

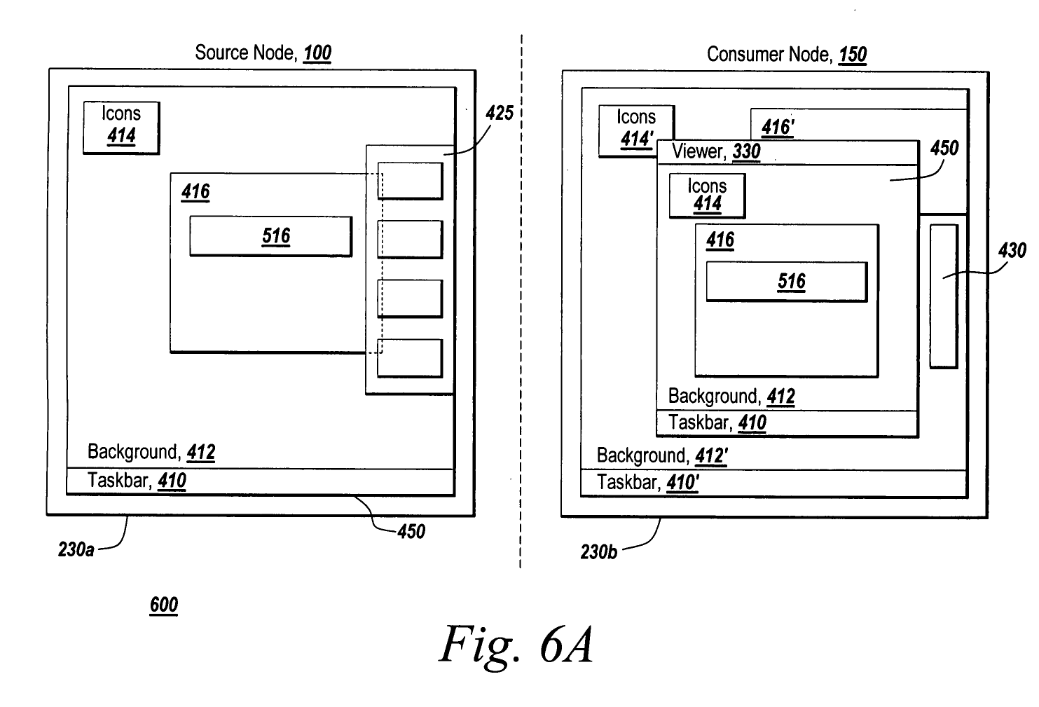

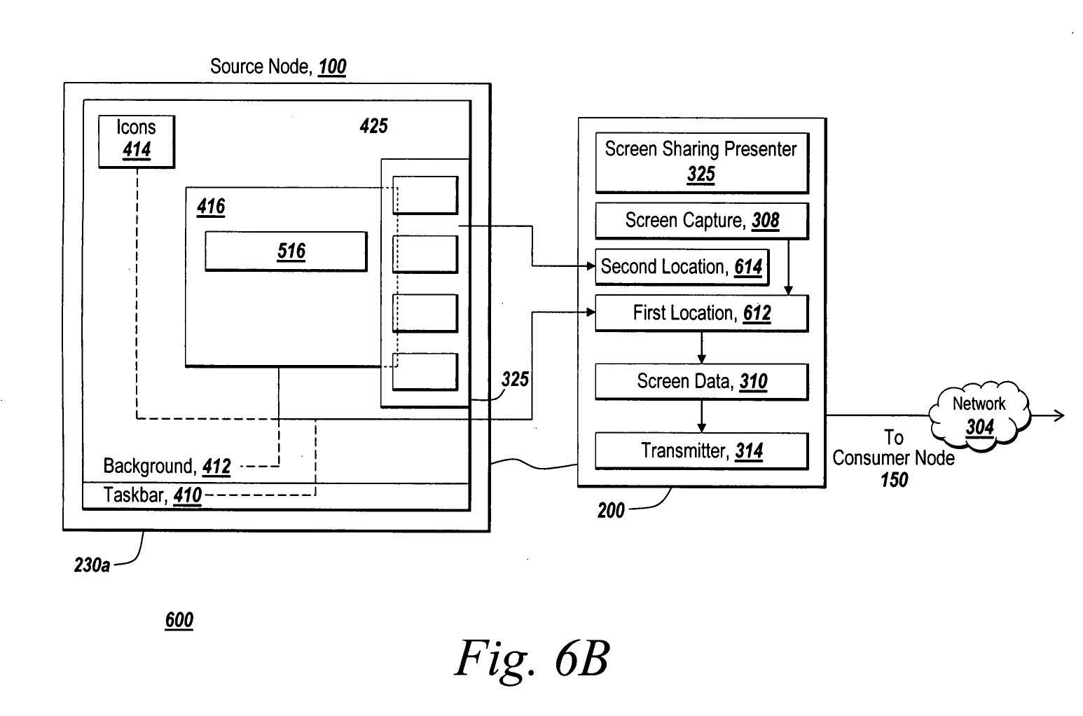

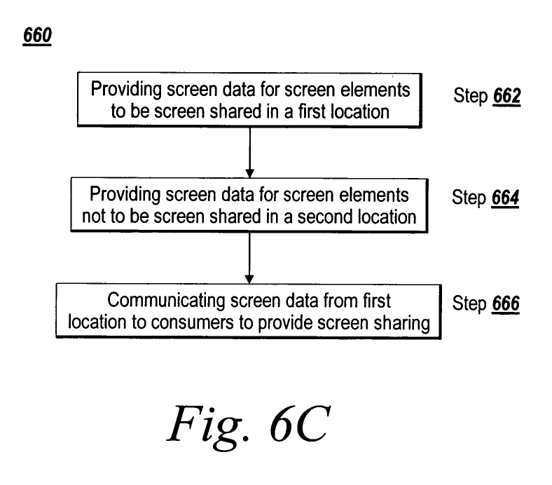

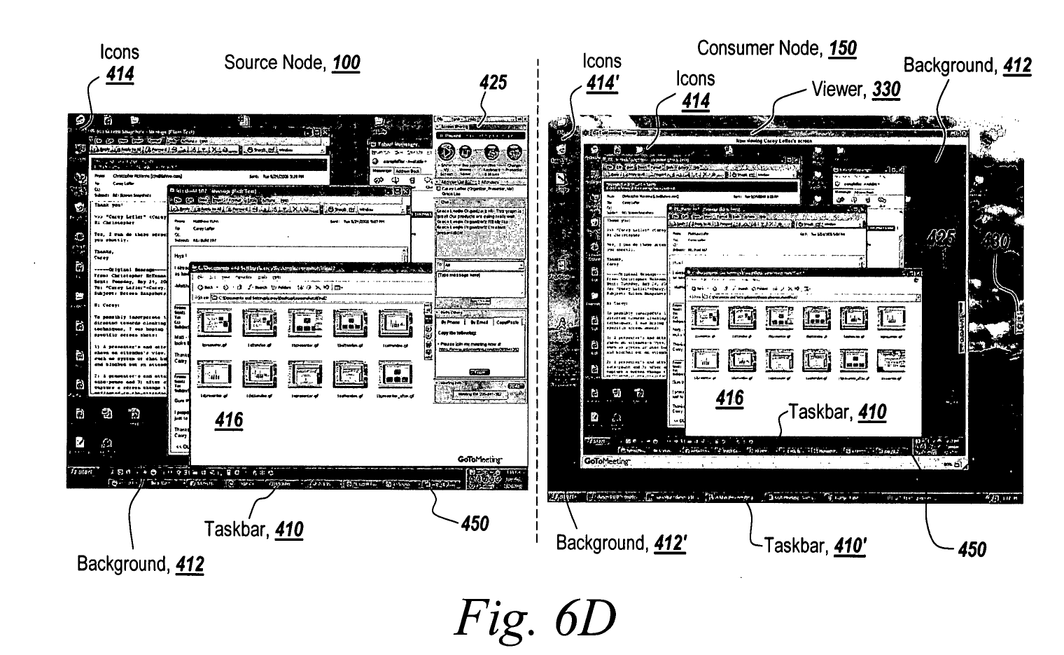

In one aspect, the present invention is related to providing techniques for selectively sharing screen data between a source node 100 and one or more consumer nodes 150-150″. The illustrative embodiment of the present invention is directed towards the following screen sharing techniques: 1) concealing (blocking), 2) automatic pausing (auto-pause), and 3) layered windows for selectively sharing screen data. The concealing technique will be discussed in conjunction with FIGS. 4A, 4B and 4C, the auto-pause technique in conjunction with FIGS. 5A-5G, and the layered windows technique in conjunction with FIGS. 6A-6D. Each of the techniques provides systems and methods for a presenting screen sharing environment, such as for a presenter in an online meeting, to selectively screen share only portions of the screen to one or more screen sharing viewer environments, such as by attendees participating in an online meeting with the presenter. These techniques effectively conceal or prevent from sharing portions of the screen desired not to be screen shared with a screen sharing viewer 330 or consumer node 150.

FIGS. 4A and 4C depict an illustrative environment 400 of screen sharing between a source node 100 and a consumer node 150. A presenter of the source node 100 is sharing a screen view on display device 230a with consumer node 150. An attendee on the consumer node 150 is viewing the screen share on display device 230b. In brief overview of FIG. 4A, the display 230a comprises a screen view 450 for viewing any viewable portions displayed via the environment of the computing device 200. In the illustrative example of FIG. 4A, the screen view 450 comprises a desktop computing environment including a background 412, a taskbar 410, and any desktop icons 414. The background 412, taskbar 410, and icons 414 may comprise any suitable type and/or form of respective elements known to those ordinarily skilled in the art which may be provided via the computing device 200, such as by the operating system or any other software, or as configured by one or more users of the computing device 200. For example, the background 412, taskbar 410, and icons 414 may include any such background, taskbar and icons provided by any of the Microsoft Windows family of operating systems.

The source node 100 may also execute one or more applications, such as an application 416 desired to be screen shared. The application 416 may comprise any type and/or form of software capable of running or being displayed in the display 230a of the source node 100. For example, the application 416 may be a Web Browser (e.g. a Microsoft® Internet Explorer browser and/or Netscape™ browser). In some embodiments, the application 416 may be any thin-client or server-based computing client such as any application 416 using the Independent Computing Architecture (ICA) of Citrix Systems, Inc. of Fort Lauderdale, Fla., or the Remote Desktop Protocol (RDP) client from Microsoft Corporation of Redmond, Wash. FIG. 4C depicts an illustrative example of the block diagram of FIG. 4A using Microsoft PowerPoint as the application 416.

On the display 230a of source node 100, the screen sharing presenter 325 may provide and display a control panel 425. The control panel 425 may include any type and/or form of one or more user interface elements for interacting with the functionality provided by the screen sharing presenter 325, such as the control panel illustrated in FIG. 4C. For example, the control panel 425 may include the list of invitees or attendees for an online meeting or a chat tool for communicating with or receiving communication from any invitee or attendee. Additionally, the control panel 425 may include a screen sharing status indicator to indicate if the sharing of screen data is occurring or if the meeting is active. The control panel 425 may include any screen sharing control functions to start, pause, continue, or stop the screen sharing and/or online meeting. In one embodiment, the control panel 425 may be implemented as a grab tab to enable a presenter to minimize the control panel 425 to the side of the screen to display more of the desktop for screen sharing but still have access to tools provided via the control panel 425.

The control panel 425 may have a minimized (undeployed) state and a maximized state (deployed) state. FIG. 4A illustrates the control panel 425 in a deployed or maximized state. In the minimized state, the control panel 425 may take the form of a smaller task bar type user interface element or otherwise a user interface element smaller in size than in the maximized state. In the minimized or undeployed state, the control panel may be selectable to restore or deploy to the maximized or deployed state.

Additionally, the screen sharing presenter 325 may provide a multitude of other type of user interface elements 425′ for interacting with and presenting information related to the functionality and operations of the screen sharing presenter 325. In some embodiments, the user interface element 425′ may comprise any type and/or form of a dialog, a popup menu, a tool tip, a chat bubble, and/or a system bubble, such any of the type and/or form of user interface elements provided by GoToMeeting.com from Citrix Systems, Inc., WebEx.com from WebEx, Inc., or LiveMeeting from Microsoft Corporation. These user interface element 425′ may also comprise a deployed state where it is displayed from an undisplayed state or restored, maximized or otherwise deployed from a minimized or hidden state. The user interface element 425′ may also have an undeployed state which comprise the user interface element 425′ being minimized, removed from the display 230a, hidden from view 450 of the display 230a, or otherwise not displayed or undisplayed. Furthermore, the user interface element 425′ may be deployed and undeployed one or more times in the screen view 450 during screen sharing or during execution of the screen sharing presenter 325.

The concealing techniques of the present invention will be discussed in view of the illustrative method 460 of FIG. 4B in conjunction with the screen sharing environment 350 of FIG. 3 and environment 400 of FIG. 4A In brief overview, illustrative method 460 provides screen sharing between a source node 100 and a consumer node 150, and detects the deployment of a user interface element 425, 425′ in the screen view 450 of the source node 100. It may be desired that the user interface element 425, 425′ is not screen shared with the consumer node 150. Instead of providing the user interface element 425, 425′ in the screen data 310 shared with the consumer node 150, the source node 100 provide a cloaking element 435, 435′ in the screen data 310 to hide or conceal the user interface element 425, 425′. The screen data with the cloaking element is communicated to the consumer node 150, which display's the screen view 450 of the source node 100 but with the cloaking element 435, 435′ instead of the user interface element 425, 425′. When the user interface element 425, 425′ is no longer deployed or displayed in the screen view 450 of the source node 100, the cloaking element 435, 435′ is removed from the screen data 310 which is communicated to the consumer node 150. As such, the consumer node 150 will display the source node's 100 screen view 450 without the cloaking element 435, 435′.

At step 462 of illustrative method 460, screen sharing is provided between a source node 100 and one or more consumer nodes 150-150″. In providing screen sharing, screen data 310 is transmitted from the source node 100 to the consumer node 150-150″ as discussed above in conjunction with FIG. 3. The consumer node 150 displays the screen data 310 of the source node 100 on it's display device 230b via the screen sharing viewer 330 as illustrated in environment 400 of FIG. 4A.

The screen sharing viewer 330 on the consumer node 150 may display the screen view 450 of the source node 100. In one embodiment, the source node 100 may share the entire desktop of the display 230a with the consumer node 150-150″ to form the screen view 450 displayed on both the display 230a and the screen sharing viewer 330. In other embodiments, the screen view 450 may comprise any portion of the display 230a or screen, virtual or otherwise. For example, the screen view 450 shared between the source node 100 and consumer node 150-150″ may comprise just a view of an application, such as application 416.

In addition to display the screen data 310 in the screen sharing viewer 330, the display 230b may also display other screen or user interface elements that may be provided via the computing device 200 of the consumer node 150. For example, as illustrated in FIG. 4B, the consumer node 150 may display a background 412′, a task bar 410′, and desktop icons 414′ the same, similar to or different from the background 412, a task bar 410, and desktop icons 414 of the source node 100. Also, the consumer node 150 may execute or display one or more applications, such as application 416′. From one perspective, the consumer node 150 may be displaying two desktop environments, or any portions thereof on the display 230b: the desktop environment provided by the computing device 200 of the consumer node 150 and the desktop environment provided by the screen data 320 displayed in the screen sharing viewer 330. Furthermore, the screen sharing viewer 330 may also have a user interface element 430, such as a control panel, for configuring and/or interfacing with any functionality or operations of the screen sharing viewer 330.

At step 464 of illustrative method 460, a user interface element, such as the control panel 425 or the user interface element 425′, is deployed or displayed in the screen view 450 of the display 230a of the source node 100. The detector 312 of the source node 100 may detect the deploying of the control panel 425 or the user interface element 425′. The screen sharing presenter 325 or any component of the source node 100 may be configured to indicate, identify, or specify the control panel 425 or the user interface element 425′ as a portion of the screen view 450 to not be included in screen sharing with the consumer node 150. For example, the screen sharing presenter 425 may have a user interface for configuring which elements of the screen view 430 or which elements of the screen sharing presenter 425 to not screen share with a consumer node 150. In some embodiments, the screen sharing presenter 325 is downloaded or otherwise provided by the screen sharing application 320 with a pre-configuration of which elements or portions of the screen view 450 that will not be screen shared. One ordinarily skilled in the art will recognize and appreciate the multitude of ways to select, specify or configure one or more elements of the screen sharing viewer 330 or screen view 450 to not be included in the screen sharing.

At step 466, the concealing technique of illustrative method 460 provides a cloaking element or blocking element 435, 435′ in the screen data 310 to be transmitted or otherwise provided to the consumer node 150. The screen sharing presenter 325, screen capturing mechanism 308, detector 308 and/or transmitter 310 of source node 100 may provide the cloaking element 435, 435′ in the screen data 310. In other embodiments, the screen sharing application 320 and/or the communication service 300 may provide for or change the screen data 310 to include the blocking element 435, 435′. In yet a further embodiment, the consumer node 150 may provide for or change the screen data 310′ to include the blocking element 435, 435′.

The blocking element 435, 435′ may comprise any screen data 310, 310′ representing an element to display on the consumer node 150 other than the user interface element 425 or control panel 425 as it is displayed on the source node 100. In one embodiment, the blocking element 435, 435′ is a logo, such as a corporate logo, for example, the logo 435 illustrated in FIG. 4C. In some embodiments, the blocking element 435, 435′ is any type and/or form of picture, graphic, image or object. In other embodiments, the blocking element 435, 435′ is a filled in rectangle of a size and shape to cover the area in the screen data 310, 310′ that would have included the user interface element 425′ or control panel 425. In one embodiment, the blocking element 435, 435′ is a grayed out, washed out, distorted, redacted or otherwise transformed version of the user interface element 425′ or control panel 425. In a further embodiment, the blocking element 435, 435′ may comprise a second user interface element or second control panel, such as a dummy, template or static copy of the user interface element 425 or control panel 425′. The dummy, template, or static copy may have any information desired to be hidden from the consumer node 150 removed.

In another aspect, the concealing techniques of the illustrative method 460 can be used to deliver a second user interface element 435′ or second control panel 435 to a consumer node 150 instead of the first user interface element 425′ or first control panel 425. Any type and/or form of second user interface element 435, 435′ can be provided in the screen data 310 in practicing these techniques of the present invention. As such, the source node 100 can selectively control and manipulate what screen data 310 is shared with the consumer node 150 and displayed on the screen sharing viewer 330, and can replace any element or portion of the screen view 450 of the source node 100 with a different element or portion to be displayed in the screen view 450 of the consumer node 150. Those ordinarily skilled in the art will recognize and appreciate that the blocking element 435, 435′ may take many different forms and any desired forms in practicing the operations of the present invention.

At step 468 of illustrative method 460, the screen data 310 with the cloaking element 435, 435 is communicated to the one or more consumer nodes 150 screen sharing with the source node 100 or otherwise receiving screen data 310. The screen data 310 may be communicated from the source node 100 over the network 304 to the consumer node 150 with or without the communication service 300. At step 470 of illustrative method 460, the consumer node 150 receives the screen data 310′ via the receiver 316 and displays the screen data 310′ in the screen sharing viewer 330. Since the screen data 310′ comprises a blocking element 435, 435′ instead of screen data 310 for the control panel 425 or user interface element 425′, the screen sharing viewer 330 displays the blocking element 435, 435. Thus, any users or viewers of the screen sharing viewer 330 on the consumer node 150 do not see or view the control panel 425 or user interface element 425′ that is displayed in the screen view 450 of the source node 100.

At illustrative step 472, the control panel 425 or the user interface element 425′ deployed or displayed in the screen view 450 of the display 230a of the source node 100 may become undisplayed or undeployed. The detector 312 of the source node 100 may detect the undeploying of the control panel 425 or the user interface element 425′. In response to or upon detection, at illustrative step 474, the blocking element 435, 435′ is removed from the screen data 310. As screen data 310 is transmitted to the consumer node 310 at step 476, the screen data 310 is provided for the entire screen view 450 without changes or manipulation. As such, the screen data 310′ processed by the consumer node 150 represents the screen view 450 of the source node 100 without any selective portions concealed or blocked. At step 478, the consumer node 150 displays the screen data 310′ via the screen sharing viewer 330.

Referring now to FIGS. 5A-5I, an illustrative embodiment of the auto-pausing technique of the present invention will be described. FIGS. 5A-5D depict an illustrative environment 500 of a screen sharing of a presenter on display 230a of the computing device 200 of a source node 100, and a screen sharing view of an attendee on a display device 230b of the computing device 200 of a consumer node 150. FIG. 5E depicts steps of practicing the illustrative method 560 of the auto-pausing technique of the present invention. FIGS. 5F-5I depict illustrative examples of the block diagrams of FIGS. 5A-5D using a Microsoft PowerPoint application during the screen share.

In brief overview of the environment 500, the display 230a comprises a screen view 450 that may include a desktop computing environment having a background 412, a taskbar 410, and any desktop icons 414. The source node 100 may also execute one or more applications, such as an application 416 desired to be screen shared. At step 562 of illustrative method 560, the consumer node 150 may be screen sharing and displaying the screen view 450 of the source node 100 via the screen sharing viewer 330 in accordance with the operations of the present invention described herein. For example, as illustrated in FIG. 5F, a Microsoft PowerPoint application 416 may be shared between the source node 100 and the consumer node 150. On the display 230a of source node 100, the screen sharing presenter 325 may provide and display a control panel 425. As illustrated in the environment 500 of FIG. 5A, the control panel 425 may be in an undeployed or minimized state during screen sharing. In the undeployed state, the control panel 435 may be screen shared with the consumer node 150 so that the screen share viewer 330 displays the control panel 425 in its undeployed state. That is, in some embodiments, the source node 100 transmits screen data 310 to the consumer node 150 providing screen data representing the control panel 425 in the undeployed state.

In brief of illustrative method 560 of FIG. 5E, the present invention provides screen sharing between a source node 100 and a consumer node 150, and detects the deployment of a user interface element 425, 425′ in the screen view 450 of the source node 100. It is desired that the user interface element 425, 425′ is not screen shared with the consumer node 150. Upon detecting the deployment of the user interface element 425, 425′, the source node 100 automatically pauses the transmission of screen data 310 to the consumer node 150. During the suspension, the source node 100 may detect and manage any changes to the screen to update the consumer node upon resuming transmission. When the user interface element 425, 425′ is no longer deployed or displayed in the screen view 450 of the source node 100, the transmission of screen data 310 to the consumer node 150 is resumed and the source node 100 updates the consumer node 150 with screen changes.

At step 564 of illustrative method 560, the control panel 425 becomes deployed or maximized in the screen view 450 of the display 230a of the source node 100 as illustrated in FIG. 5B and FIG. 5G. As such, the control panel 425 may comprise a larger portion of the screen view 450 screen shared with the consumer node 150. Additionally, the control panel 425 may block, cover or be displayed over other portions of the screen view 450, such as a portion of application 416. At step 566, the detector 312 of the source node 100 detects the deploying of the control panel 425 and the transmission of screen sharing is automatically paused, suspended or halted in response to the detection. In one embodiment and as illustrated in FIG. 5B and FIG. 5G, the control panel 425 provides an indicator 526 of the status of screen sharing and may indicate that the screen sharing has been suspended or otherwise automatically paused. Although the indicator 526 is described as provided by the control panel 425, such an indicator 526 may be provided by the screen sharing presenter 425 or in any other portion of the screen view 450 or display 230a. Also, as illustrated in FIG. 5B, when the screen sharing is automatically paused, the screen view 450 displayed in the screen sharing viewer 330 of consumer node 150 does not show the deployed control panel 425. For example, the screen sharing viewer 330 may display the last set of screen data 310′ received from the source node 100 which shows the control panel 425 in the undeployed state, i.e., minimized. In some embodiments, the control panel or user interface element 430 of the screen sharing viewer 330 may provide an indication that screen sharing or the transmission of screen data 310 has been suspended.

During the suspension of transmission of screen data 310, the techniques of the present invention at illustrative step 568 detect and manage any changes in the screen view 450 and/or corresponding screen data 310 of the source node 100. For example, as illustrated in FIG. 5B and FIG. 5H, during the auto-paused state, the application 416 may have any type and/or form of screen change 516, such as an update to a web-page or a change in information on a document. During the auto-paused state, the user of the computing device 200 of the source node 100 may perform one or more user interactions that change the screen view 450. For example, as illustrated in FIG. 5H, the user may invoke another application or view another document, such as the Microsoft Word application to view a Microsoft Word document. In other cases, the application 416, or the operating system or other software of the computing device 200 may automatically provide the screen change 516 based on its designed behavior, functionality or operations. Although this screen change 516 is displayed and viewable on the source node 100, the screen sharing viewer 330 does not display the screen change 516 since the transmission of screen data 310 has been suspended.

In one aspect, the source node 100 queues screen changes 516 during the suspension of transmission of screen data 310 to the consumer node 150 so that upon resuming transmission the source node 100 can update the consumer node 150 with one or more screen changes that may have occurred during suspension. In one embodiment, the source node 100 may queue screen change 516 for providing to the consumer node 150 upon resuming transmission of screen data 310. For example, as illustrated in FIG. 5H, the source node 100 may queue the screen changes 516 related to using Microsoft Word during the auto-pause state. In some embodiments, the source node 100 may queue all screen changes 516 that occur during suspension. In other embodiments, the source node 100 may only queue the latest screen change 516. In other embodiments, the source node 100 queues screen changes 516 and after a predetermined amount of time discards one or more of the screen changes 516. In further embodiments, the source node 100 may discard one or more screen changes 516 if a more recent screen change 516 is providing an update to or reflects a change to an already queued screen change 516. For example, the source node 100 may only queue the current screen change 516 for each tile representing the screen 450. In some embodiments, the source node 100 only queues those screen changes 516 not related to the deployed control panel 425 triggering the auto-pause. One ordinarily skilled in the art will recognize and appreciate the various ways for the source node 100 to queue screen changes during the suspension of transmission of screen data.

At illustrative step 570, the deployed control panel 425 may become undisplayed or undeployed as illustrated in FIG. 5C or as in FIG. 5I. The detector 312 of the source node 100 may detect the undeploying of the control panel 425. In response to or upon detection, the transmission of screen data 310 to the consumer node 150 may be resumed, continued or re-started. At illustrative step 572, screen data 310 representing one or more screen changes 516 is communicated to the consumer node 150. As illustrated in the screen sharing viewer 330 of FIG. 5C, the screen view 410 is updated to show the screen change 516 of application 416. For example, as illustrated in FIG. 5I, the consumer node 150 may be updated to receive the screen change 156 related to using Microsoft Word during the auto-pause. In another example, the consumer node 150 may be updated to reflect the current screen view 450 upon resuming which currently has Microsoft Word displayed. In some embodiments, the source node 100 provides all the screen changes 516 that were queued at step 568 during suspension of transmission. In other embodiments, the source node 100 only provides recently queued screen changes 516, such any screen change 516 that occurred within a predetermined amount of time prior to resuming transmission of screen data 310. In further embodiments, the source node 100 only provides the most recent screen change 516 for each tile representing the screen 450.

Although illustrative method 560 is discussed as providing for auto-pausing upon the deployment of the control panel 425, as illustrated in FIG. 5D, the illustrative method 560 is also applicable for auto-pausing upon detection of the displaying or deploying of any user interface element 425′ desired not to be screen shared. FIG. 5D illustrates the control panel 425 in the undeployed state, i.e., minimized in the screen view 450. As the minimized control panel 425, in some embodiments, does not trigger the automatic pausing technique, the screen data 310 representing the control panel 425 is communicated to the consumer node 150 and displayed in the screen view 450 of the screen sharing viewer 330. In some embodiments, at step 566 of illustrative method 560, the deploying or displaying of a user interface element 425′ may be detected and transmission of screen data 310 automatically suspended. The user interface element 425′ may be any user interface element desired not to be screen shared with the consumer node 150 or otherwise kept hidden or private from screen sharing: For example, the user interface element 425′ may comprise a private, a sensitive, or confidential communication, such as a user communication. In other examples, the user interface element 425′ may comprise a form of interaction with the functionality and operations of the screen sharing presenter 325. As illustrated in FIG. 5D, the auto-pausing technique suspends transmission of screen data 310 upon detection of deploying the user interface element 512′ and the screen sharing viewer 330 does not display the user interface element 425′. Those ordinarily skilled in the art will recognize and appreciate how illustrative method 560 may also be practiced with a user interface element other than the control panel and with a user interface element that is displayed and undisplayed instead of deployed and minimized.

Referring now to FIGS. 6A-6D, an illustrative embodiment of the window layering technique of the present invention will be described. FIGS. 6A, 6B and FIG. 6D depict an illustrative environment 600 of a screen sharing of a presenter on display 230a of a source node 100, and a screen sharing view of an attendee on a display 230b of a consumer node 150. FIG. 6B depicts steps of practicing the illustrative method 660 of the window layering technique of the present invention. FIG. 6D depicts an illustrative example of the block diagram of FIG. 6A showing a windows file explorer and Microsoft Outlook with emails in the desktop view 450.

In brief overview of the environment 600 of FIG. 6A, the display 230a comprises a screen view 450 that may include a desktop computing environment having a background 412, a taskbar 410, and any desktop icons 414. The source node 100 may also execute one or more applications, such as an application 416 desired to be screen shared. Using the window layering technique of the present invention, the source node 100 may display the control panel 425, or any user interface element, and transmit a set of screen data 310 that does not provide the control panel 425 or user interface element for display on the screen sharing viewer 320. As such, any screen changes 516 may be screen shared with the consumer node 150 as they occur without screen sharing a portion of the screen view 450 desired not to be shared. For example, as illustrated in FIG. 6D, the consumer node 150 may view the screen view 450 of the source node 100 without showing the deployment of the control panel 425. In some embodiments, the consumer node 150 receives screen data 310′ from the source node 100 to display the portion of the screen view 450 behind the deployed control panel 425 instead of the deployed control panel 425.

FIG. 6B depicts another illustration of environment 600 providing a mechanism for storing a first portion of screen data in a first location 612 and a second portion of screen data in a second location 614. The first location 612 and second location 614 can comprise any suitable means and/or mechanism for writing or storing any representation of a portion of the screen view 450, such as the control panel 425, the application 416, and the background 412, task bar 410 and icons 414 of the desktop. The first location 612 and second location 614 can be any type and/or form of memory or storage. The first location 612 and second location 614 may comprise software, hardware, or any combination of software and hardware.

In brief overview of illustrative method 660 of FIG. 6C, the present invention stores screen data 310 desired to be screen shared to a first location 612, and screen data 310 desired to be excluded from screen sharing to a second location 614, such as by using layered windows. The illustrative method then transmits screen data from the first location 612 to the consumer node 150, so that the consumer node 150 only views screen data from the first location 612.

Referring to FIG. 6B, in some embodiments, the first location 612 and/or the second location 614 comprises data structures or data elements in memory associated with representing a user interface or screen element on the display 450. For example, the first location 612 and/or second location 614 may comprise any data element provided by an application programming interface for creating, displaying, or managing windows or user interface elements, such as any of the application programming interfaces provided by the Microsoft family of Windows operating systems. Additionally, the first location 612 and second location 614 may comprise any memory provided via an application programming interface to hold information and/or data related to creating, generating, or otherwise providing a window, an image, or any other screen element.

In other embodiments, the first location 612 and/or the second location 614 may comprise a portion of any graphics processing related hardware, firmware, storage, or memory of the computing device 200 or related to the display device 230a, such as any video memory, a graphics processor, or a graphics card. In further embodiments, the first location 612 and/or the second location 614 may comprise any type and/or form of suitable window buffering mechanism and/or means, such as a window frame buffer. One ordinarily skilled in the art will recognize and appreciate the first location and second location may comprise many different forms for holding screen data, or any representation related to displaying an element in the screen view or otherwise on the display.

Although generally described as a first location and a second location, one ordinarily skilled in the art will recognize and appreciate the first location and second location could be part of the same location with portions identified or associated with a first set of screen data and another portion identified or associated with a second set of screen data Additionally, a first plurality of locations may be used for a first set of screen data and a second plurality of locations may be used for a second set of screen data.

At step 662 of illustrative method 600 the source node 100 may store screen data for screen elements to be screen shared to the first location 612. As illustrated in FIG. 6B, any portion of the screen view 450 desired to be screen shared is stored, written to, or otherwise provided to the first location 612. For example, in one embodiment, any screen data representing the background 412, taskbar 410, icons 414 and the application 416 may be stored in the first location. In some embodiments, the screen data stored at the first location 612 comprises any of the windows and user interface elements created and displayed via a non-layered Microsoft Windows application programming interface. In these embodiments, any window or user interface element created in a standard or conventional manner may be screen captured by the screen capturing mechanism 308 and stored as screen data in the first location 612.

At illustrative step 664, any portion of the screen view 450 desired not to be screen shared is stored to the second location 614. As illustrated in FIG. 6B, for example, the screen data for the control panel 425 is stored, written to, or otherwise provided to the second location 614. In an exemplary embodiment, screen data for the control panel 435 may be stored in the second location 614 via the use of the Microsoft window layering application programming interface (API). Microsoft Layered Windows provides an extended window style indicated by a window style bit of WS_EX_LAYERED. For example, the control panel 425 could be created and established as a layered window by setting the WS_EX_LAYERED bit at window creation time, for example, via the CreateWindowEx API call, or setting WS_EX_LAYERED bit via SetWindowLong API call after the window has been created.

The Microsoft Layered Windows API provides the ability for the redirection of the drawing of windows into an off-screen bitmap and buffer, such as the second location 614, as well as for transparency and translucent display effects of windows. One or more Layered Windows API calls may be used in practicing the operations of the present invention, such as SetLayeredWindowAttributes, and UpdateLayeredWindow functions. Those ordinarily skilled in the art will recognize and appreciate using the Layered Windows API call for redirection and off-screen buffering of layered windows. Furthermore, although generally discussed using Layered Windows API of a Microsoft operating system, those skilled in the art will recognize and appreciate using other window management systems and related API calls on other operating systems, such as X-Windows on a UNIX based operating system.

Additionally, the control panel 425 window or any other user interface element desired not to be screen shared may have any other attribute set to indicate the window or user interface element should not be screen shared. For example, a custom attribute of a window may be set to indicate the window should not be screen shared or otherwise stored to the second location 614. In other embodiments, any portion of the screen view 450, such as the control panel 425 or a user interface element 425′ or any area or image, may be tagged or tracked as a portion not to be stored in the first location 612. One ordinarily skilled in the art will recognize and appreciate that any portion of the screen view may be tracked as a portion to be stored to the second location 610 or otherwise not to be stored to the first location 612.

In one embodiment, the screen capture mechanism 308 does not screen capture or ignores any layered windows, such as any windows with the WS_EX_LAYERED bit set. In some embodiments, the screen capture mechanism 308 does not capture or provide screen data for any windows or screen elements stored in off-screen buffering, e.g., the second location 614. In other embodiments, the screen capturing mechanism 308 captures screen data for the layered windows but stores the screen data in the second location 614. In further embodiments, the screen capture mechanism 308 may not screen capture or otherwise ignores any portion of the screen view 450 identified as a portion not to be stored to the first location 612.

At step 666 of illustrative method 660, the screen data from the first location is transmitted to the consumer node 150. For example, in some embodiments, screen data 310 is provided via the screen data stored in the first location 612. In these cases, only the screen representation stored in the first location is provided for screen sharing to the consumer-node 150 for displaying in the screen sharing viewer 330. The source node 100 may display the screen elements stored to the first location 612 and the second location 614, while the consumer node 150 only receives screen data 310 having screen elements from the first location 612. As illustrated in FIG. 6A, the control panel 425 may be provided as a layered window or otherwise stored to the second location 614. The screen data for the control panel 425 is stored in the second location 614 and therefore, is not included in the screen data 310 transmitted to the consumer node 150.

In one aspect, the screen sharing techniques of the present invention may be practiced in one or more combinations. The concealing technique may be practiced in combination with the auto-pausing technique and/or the layered window technique. For example, when the control panel 425 is minimized it may be concealed via a blocking element of a logo when screen shared with the consumer node 150. While the control panel 425 is concealed, a user interface element of the screen sharing presenter 425 may be provided as a layered window and not transmitted in the screen data 310 transmitted to the consumer node 150. Furthermore, some user interface elements, such as application or system error messages, may cause the automatic pausing of the transmission of screen sharing. One ordinarily skilled in the art will recognize and appreciate how the screen sharing techniques of the present invention may be practiced in various combinations.

In a further aspect, the present invention is directed towards practicing any of the screen sharing techniques, alone or in combination, using bandwidth-adaptive systems and methods and/or by representing the screen as a plurality of tiles. In some embodiments, the present invention provides synchronization of dynamic data sets to multiple consumer nodes that adapts to available bandwidth by discarding transient states of the data set. The systems and methods of the present invention may utilize the bandwidth available to each consumer node and may provide a simple, efficient and reliable mechanism for synchronizing dynamic data, such as screen data 310, 310′. The present invention may host multiple one-to-many sessions, such as screen sharing sessions, and allow consumer nodes 150 to join an ongoing one-to-many session at any time. Additionally, the system also supports end-to-end encryption of data.

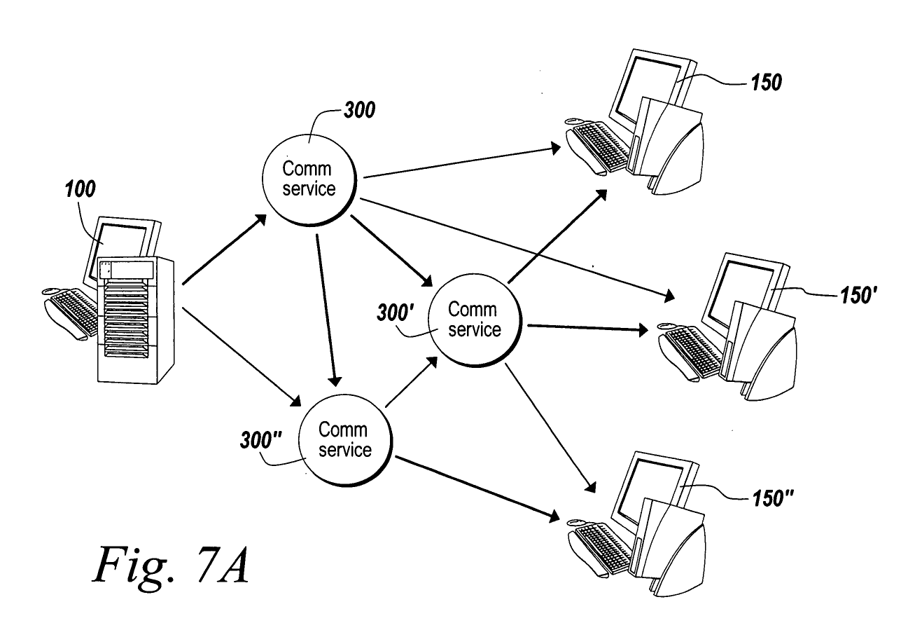

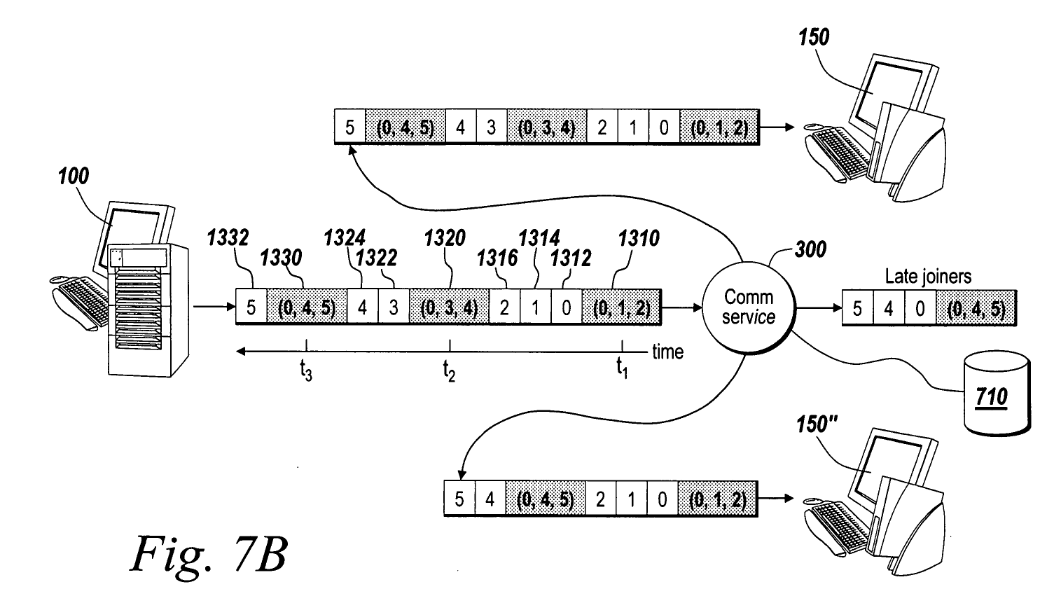

Referring to FIG. 7A, an environment is depicted for practicing the bandwidth-adaptive techniques of the present invention. The system of FIG. 7A may be used for synchronizing a data set between the source node 100 and a plurality of consumer nodes 150, 150′ and 150″, as well as the packet flow in a system during operation. The source node 100 codes the current state of a dynamic data set, such as screen data, as a set of data packets. In some embodiments, this coding process is straightforward. For example, in the case where the dynamic data set is screen data, data packets may be coded by storing pixel values for a predetermined portion of the screen in the data packet. In some embodiments, the source node 100 compresses the data stored in the data packets. In still other embodiments, the source node 100 encrypts the data stored in the data packets. In still further embodiments, the source node 100 both encrypts and compresses data stored in the data packets. As the dynamic data set changes, the source node updates the set of data packets comprising the current state of the data set.

The source node 100 transmits the current state of the dynamic data set to the communications service 300 in a bandwidth-adaptive manner. In one embodiment, this is achieved by requiring the source node 100 to possess a transmission token before beginning transmission of the current state of the data set. In this embodiment, the source node 100 and the communications service exchange a limited number of transmission tokens, e.g., five. In other embodiments, the communication service 300 transmits a message to the source node 100 to notify the source node 100 when it can send another data set update.

FIG. 7A depicts a block diagram of a system for using one or more communication services 300-300″ to exchange data between the source node 100 and a plurality of consumer nodes 150, 150′, 150″. For example, the one or more communication services 300-300″ may be used to facilitate and provide communication services for online collaboration and web conferencing, such as for an online meeting. As shown in FIG. 3A, the system includes a communications service 300 with which the source node 100 and the plurality of consumer nodes 150, 150′, 150″ communicate. The source node 100 and the consumer nodes 150, 150′, 150″ may be located behind respective firewalls (not shown in FIG. 3). Similarly, each consumer node 150, 150′, 150″ may also communicate with one or more communication services 300. In one embodiment, the communication services 300-300″ may communicate in a peer-to-peer fashion with each other.

The source node 100 and the consumer nodes 150, 150′, 150″ may communicate to one or more of the communications services 300-300″ via socket-based connections or by any other suitable means and/or mechanism. In some embodiments, the communications service 300 maintains the state for each connection to a consumer node 150, 150′, 150″. In other embodiments, the source node 100 and the communications service 300 may be provided on the same computing device 200 and may interface and communicate locally using any one of a number of techniques, such as pipe objects or shared memory.

In some embodiments, the communication services 300-300″ may agree between themselves on a direction for data flow. For example, communication service 300 and communication service 300′ may agree between themselves that, for the purposes of their point-to-point link, communication service 300 is the “sender” and communication service 300′ is the “receiver,” meaning that the “sender” will perform the role of the communication service 300. The communication server 300′, however, may perform the role of a “sender” when communicating with consumer nodes 150, 150′, 150″

Although the communication services are generally illustrated and described in a distributed manner with multiple services, there may be a single communication service on the source node or the consumer node or any intermediate node, such as any type of computing device 200. Additionally, each of the source node, consumer node, or any intermediate node may run a portion of the communication service 300. One ordinarily skilled in the art will recognize and appreciate that one or more communication services, and any portions thereof, may be deployed in a variety of ways on one or more computing devices, or source and consumer nodes.

Referring now to FIG. 7B, the communications service 300 may also include a data storage element 710, such as random-access memory, a disk drive, a disk array, a rewriteable optical drive, or some other type and/or form of storage or memory element that allows access to stored data. The storage element 710 enables the communications service 300 to store metadata information and data packets received from the source node 100 in between update requests from various consumer nodes 150, 150′, 150″. In addition, the storage element 710 can be used to maintain a historical record of metadata information and data packets transmitted from the source node 100. In other embodiments, the storage element 710 may also store the data packets transmitted to a respective consumer node 150, 150′, 150″. For example, the communication service 300 may use the data storage 300 to provide a queue for any data and information transmitted or to be transmitted between a source node 100 and consumer node 150. For example, in some embodiments, the communication services 300-300″ provide for the transmissions and queuing of data packets representing screen data to be shared by the source node 100 with the consumer nodes 150, 150′, 150″.

The source node 100 creates metadata information that identifies each of the data packets representing the current state of the dynamic data set. In the embodiment shown in FIG. 7B, the metadata information comprises a metadata packet 1310, 1320, 1330. Metadata packet 1310 is created at time t1, and indicates that the state of the dynamic data set at time t1 is represented by data packet 0, data packet 1, and data packet 2. Similarly, metadata packet 1330 indicates that state of the dynamic data set at time t2 is represented by data packet 0, data packet 4, and data packet 5. In other embodiments, instead of creating metadata packets that store metadata information, metadata information is included in data packets. For example, each data packet comprising a data set update may include a “metadata information header” identifying the update set with which the data packet is associated.

As shown in FIG. 7B, the source node 100 transmits metadata information 1310 to the communications service 300 followed by the data packets identified by the metadata information 1310. Thus, the source node 100 transmits to the communications service 300 data packet 0 1312, data packet 1 1314, and data packet 2 1316 following the metadata packet 1310. At time t2, the source node 100 transmits to the communications service 300 metadata packet 1320, which indicates that the state of the data set at time t2 is represented by data packet 0, data packet 3, and data packet 4. The source node 100 then transmits data packet 3 1322 and data packet 4 1324 to the communications service 300. The source node 100 does not retransmit data packet 0 to the communications service 1300 since that data packet was transmitted in connection with the first metadata packet 1310. Similarly, at time t3 the source node 100 transmits to the communications service 300 a metadata packet 1330 that indicates the current state of the dynamic data set is represented by data packet 0, data packet 4, and data packet 5. Since the source node 100 already transmitted data packet 0 to communications service 300 following the first metadata packet 1310 and data packet 4 following the second metadata packet 1320, the source node 100 only transmits data packet 5 1332 following the third metadata packet 1330.

As described above in connection with flow control between the source node 100 and the communications service 300, flow control between the consumer nodes 150, 150′, 150″ and the communications service 300 may be token-based or message-based. For ease of reference, the remaining description will assume that the flow control method is based on messages. However, the same advantages of the invention can be obtained in a system relying on transmission tokens.

FIG. 7B depicts an illustrative embodiment of a system in which consumer node 150, communicates with the communications service 300 via a high-bandwidth connection. In this case, the consumer node 150 requests data set updates frequently enough that the communication service 300 transmits to the consumer node 150 a stream of metadata information and data packets identical to the stream of metadata information and packets received by the communications service 300 from the source node 100. Also as shown in FIG. 3, the consumer node 150″, which communicates with the communications service 300 via a low-bandwidth connection, requests data set updates less frequently and, therefore, receives a different stream of packets from the communications service 300 than the communications service 300 receives from the source node 100. As shown in FIG. 7B, the communications service 300 transmits the first metadata packet 1310 and data packets 0-3, 1312, 1314, 1316 to the consumer node 150″. The next metadata packet received by the consumer node 150″ is the third metadata packet 1330, which indicates that the state of the dynamic data set is represented by data packet 0, data packet 4, and data packet 5. Since the consumer node 150″ has not yet received data packet 4 and data packet 5, the communications service 300 transmits those data packets to the consumer node 150″.

FIG. 7B also depicts the packet stream sent to a consumer node 150 that “joins late.” As shown in FIG. 7B, a consumer that joins at time t3 will receive the third metadata packet 1330, as well as all the data packets identified by the third metadata packet. The data packets transmitted to the consumer node 150, 150′, 150″ by the communications service 300 may be retrieved from the storage element 710, recently received from the source node 100, or some combination of the two.

Delivery of data set updates from the communications service 300 may be performed using a “push” model, a “pull” model, or an “atomic push” model. In the “push” models, the communication service 300 transmits metadata information and data packets to the consumer node 150, 150′, 150″. The difference between the “push” model and the “atomic push” model is that, in the “atomic push” model, the communications service 300 commits to transmit every data packet identified by transmitted metadata information before beginning transmission of another data set. There is no such commitment in the “push” model, which means that data packets not successfully transmitted from a previous data set update may never be sent to the consumer node 150, 150′, 150″. In the “pull” model, the consumer node 150, 150′, 150″ receives from the communications service 300 the metadata information and then requests specific data packets from the communications service 300.

In certain embodiments, the information in metadata packets is encoded incrementally. In these certain embodiments, the “wire” representations of metadata packets may differ despite the fact that they encode the same information. A short example shows why this is the case. Over time, the source node 100 sends three metadata packets to the communications service 300. The contents of the metadata packets are sets of data packet numbers (1, 2, 3), (2, 3, 4) and (3, 4, 5). On the “wire,” each set is represented as a delta from the previous set. Thus, the source node 100 transmits the following metadata packets to the communications service 300: (1, 2, 3), (−1, +4) and (−2, +5), where ‘−’ and ‘+’ indicate removal or addition of a packet number from/to the previous set. If a consumer node 150 skips the contents of the second metadata packet, it receives metadata information describing sets (1, 2, 3) and (3, 4, 5). On the “wire,” these two sets are represented incrementally as (1, 2, 3) and (−1, +4, −2, +5). While the source node 100 transmitted the contents of the second metadata packet to the communications service 300 as (−2, +5), the communications service 300 transmitted the same information to the consumer node 150 as (−1, +4, −2, +5).

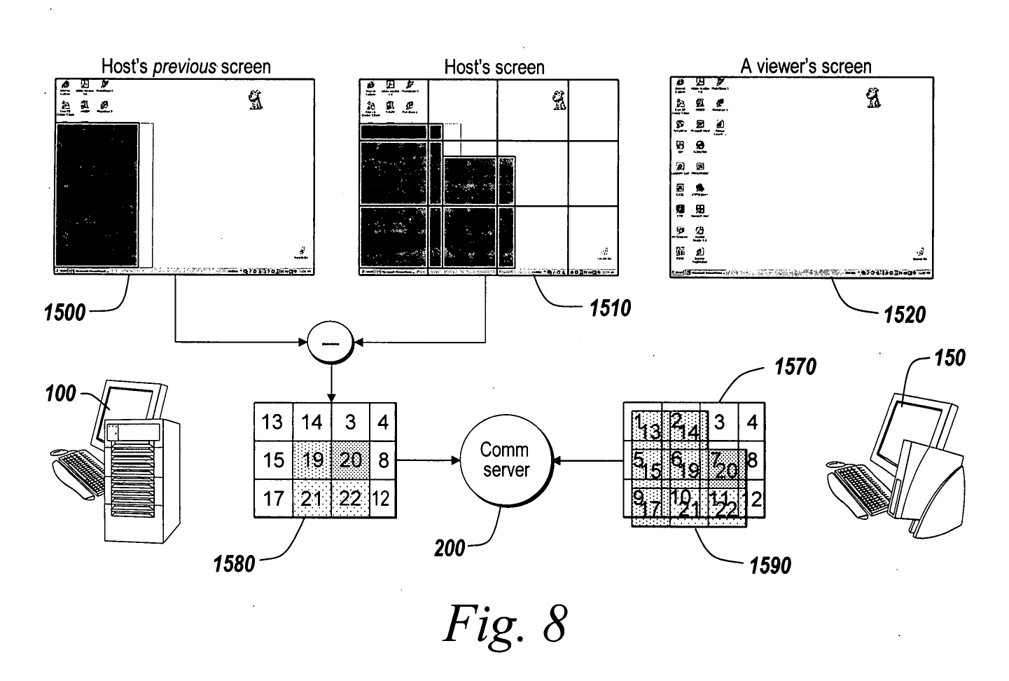

FIG. 8 depicts another embodiment of a system for synchronizing a data set between a source node 100 and one or more consumer nodes 150, 150′, 150″ that includes multiple communications services 300, 300′, 300″ (generally referred to as 300). As shown in FIG. 8, the source node communicates with more than one communications service 300. Similarly, each consumer node 150, 150′, 150″ may also communicate with one or more communication services 300. The communication services 300 also communicate in a peer-to-peer fashion among themselves.

In this embodiment, each pair of communication services 300 agrees between themselves on a direction for data flow. For example, communication service 300 and communication service 300′ may agree between themselves that, for the purposes of their point-to-point link, communication service 300 is the “sender” and communication service 300′ is the “receiver,” meaning that the “sender” will perform the role of the communication service 300 described in connection with FIG. 7B and the “receiver” will perform the role of the consumer node 150 described in connection with FIG. 7B. The communication server 300′, however, will perform the role of a “sender” when communicating with consumer nodes 150, 150′, 150″

Any or all of the embodiments of the present invention may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

### EXAMPLES

The following examples of content-sharing systems are intended to illustrate the various ways in which the described systems and methods can be used and not to limit the scope of the described invention.

### Example 1

The described bandwidth-adaptive systems and methods may be used to implement a system for sharing screen data 310 that allows several client computing devices to display the screen data from a single server. For example, this system is useful in a number of broadcast or “multicast” contexts and, in particular, it is useful in a conferencing context, such as an online meeting, to allow multiple individuals to view the same graphical data during the conference.

FIG. 8 depicts diagrammatically a system for sharing screen data. As shown in FIG. 8, a host server 100 monitors its screen state. In the embodiment shown in FIG. 8, the host server 100 subdivides its screen into 12 tiles, although any number of tiles may be used to fully represent the screen of the host server 100. In some embodiments, the tiles are each the same size, that is, each tile represents the same number of screen pixels. In other embodiments, such as the embodiment shown in FIG. 8, some of the tiles have sizes different from other tiles. In still other embodiments, a tile may overlap another tile or, as shown in FIG. 8, tiles may by non-overlapping.

As shown in FIG. 8, the host server's previous screen 1500 is represented by a first set of tiles (not shown), which are coded as a first set of data packets: 13, 14, 3, 4, 15, 6, 7, 8, 17, 10, 11, and 12. If the host server 100 possesses a transmission token, it transmits these twelve data packets to the communications server 200, as described above.

At a second point in time, the host server's screen 1510 has changed. The host server 100 identifies the particular tiles that have changed states, and creates a coded packet for each tile that has changed, i.e., data packets 19, 20, 21, and 22. If the host server 100 did not possess a transmission token but now receives one, the host server 100 will transmit the updated twelve data packets to the communications server 200, i.e., data packets 13, 14, 3, 4, 15, 19, 20, 17, 21, 22, and 12. If the host server has already transmitted the data packets representing the state of the screen 1510, then the host server 100 need only transmit to the communications server 200 data packets 19, 20, 21, and 22. In this manner, transmission of screen data between the host server 100 and the communications server 200 is performed in a bandwidth-adaptive manner.

In some embodiments, the host server 100 encrypts the data packets transmitted to the communications server 200. In other embodiments, the host server 100 compresses the data packets sent to the communications server 200. In still other embodiments, the host server 100 both encrypts and compresses the data packets.

In many embodiments, the communications server 200 maintains a copy of each tile that comprises the most recent state of the server node screen. In some embodiments, each tile is associated with a timestamp when transmitted to the communication service 200. In other embodiments, each tile is associated with a number that monotonically increases with each new tile transmitted to the communications service 300.

The communications server 200 composes an update for a viewer node 150 as often as the bandwidth of the network connecting the viewer node 150 to the communications server 200 allows. As shown in FIG. 8, the viewer's screen 1520 displays screen data from a point in time before the host's previous screen 1500. That is, the host server's display data has changed twice (represented by screen 1500 and screen 1510) since the last time the viewer node 150 has requested an update. Data packet array 1570 shows the data packets comprising the screen data currently displayed by the viewer node 150. Data packet array 1590 depicts the data packets that the communications server 200 must transmit to the viewer node 150 in order to update the viewer's screen 1520 to the state of the host's screen 1510. As described above, the communications server 200 transmits metadata information to the viewer node 150 identifying eight data packets: data packets 13, 14, 15, 19, 20, 17, 21, and 22. In some embodiments, the metadata information explicitly identifies which tile replaces which other tile, perhaps by describing the position of the new tile. The communications server 200 then transmits the packets representing the new tiles to the viewer node.

In another embodiment, the communication service 200 responds to an update request from the viewer node 150 by transmitting to the viewer node 150 every data packet having a timestamp newer than the timestamp of the viewer's screen. In some of these embodiments, the communication service 200 does not fully receive and store a set of data packets comprising a screen update before sending the update to the viewer node 150. In these embodiments, the communications service 300 sets the timestamp for each packet identified by metadata information as comprising the screen update to the same value. Then, as data packets arrive the communications service 300 streams those packets to the viewer node 150.

In one particular embodiment, metadata information is formatted into packets and metadata packets are associated with monotonically increasing numbers. As described above, each metadata packet describes the set of tiles comprising the current screen display state. In this embodiment, the communications service 300 stores, for each consumer node 150, the number of the latest metadata packet that has been transmitted to that consumer node 150, as well as the set of all data packets that have been delivered to the consumer node. When the communications service 300 determines that it is time to send an update to a consumer node 150, or upon receiving a request from a consumer node 150 for a screen update, the communications service 300 first determines if the latest metadata packet (that is, the metadata packet having the highest number associated with it) has been transmitted to the consumer node 150. If not, the communications service 300 transmits the most recent metadata packet to the consumer node 150. The communications service 300 also transmits the set of data packets identified by the metadata packet, unless a particular data packet has already been transmitted to the consumer node 150.

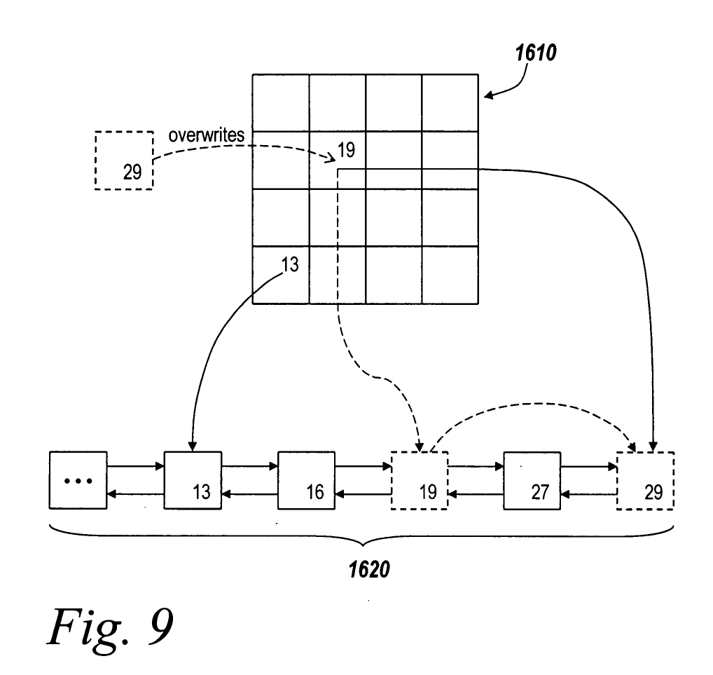

In another embodiment, the set of tiles (i.e., data packets) that must be transmitted to a consumer node is computed by associating each tile with a timestamp and identifying all visible tiles whose timestamps are newer than the newest tile already received by the consumer node 150. FIG. 9 depicts diagrammatically a data structure enabling efficient replacement of a display tile by the communications service 300 and given a timestamp, identification of which tiles are out-of-date with respect to a given consumer node 150. All tiles comprising a screen 1610 are stored in a doubly-linked list 1620 sorted by timestamp and indexed by tile location in the screen. As shown in FIG. 9, when new tile 29 overwrites old tile 19, tile 19 is removed from the list and new tile 29 is inserted at the head of the list. When a viewer node 150 requests a screen update, the communications service 300 iterates through the list of tiles 1620 and transmits tiles to the viewer node until it encounters a tile with a timestamp older than the newest tile on the viewer node screen.

### Example 2

In another example the described synchronization systems and methods are used to implement a chat system. In this system, a chat participant adds text or other content to an on going session and identifies the added content as a data packet. In one embodiment, the participant also associates a timestamp with the added content. The participant then transmits metadata information identifying the current state of the chat. In one embodiment, the metadata information identifies the current state of the chat session as the recently added packet together with every previous data packet added to the chat.

The participant transmits the metadata information together with a data packet representing the recently added content. In one embodiment, the metadata information and data packet are pushed to a receiving node, as described above. Recipients of the metadata information and data packet merge the received data packet with chat data packets already received in the order the data packets are received. In another embodiment, the recipient merges the chat data packets based on the time the data packet was sent. In still another embodiment, the recipient merges the data packets based on the timestamp associated with the data packet.

A “late joiner” to the chat session will receive metadata information identifying all data packets representing the chat session. The late joiner will either request (i.e., pull) or be sent (i.e., push) all the data packets identified by the metadata information and will display in them in timestamp order.

### Example 3

In another example, the synchronization systems and methods described above may be used to implement a remote presentation system. In this example, a presenter converts a slide presentation into a series of page-by-page images. As the presenter displays a slide, the page image representing that slide is transmitted to all viewers. In many embodiments, each slide is represented by multiple data packets.

In this example, the presenter atomically pushes the currently displayed slide by atomically pushing metadata information identifying each data packet representing the slide and pushing each data packet not yet transmitted to the receiver. The presenter may also push the previous slide and the next slide. In further embodiments, viewers may “pull” other pages in the presentation if extra bandwidth is available. Information that may be inserted into a laser pointer data packet includes, x coordinate, y coordinate, time, document, or page number.

In addition to multicasting slide presentation, this exemplary embodiment may be used to share other page-based documents. This exemplary embodiment may also support a “laser pointer” feature in which the position of a presenters “laser pointer” is also transmitted to all viewers, allowing the presenter to direct viewer's attention to areas of interest in the document.

### Example 4

In still another example, the synchronization methods and systems described above may be used to implement a system allowing multiple users to annotate a document. In this example, each annotation is represented by a data packet. Annotation data packets may include information regarding the time the annotation was made and by whom. Other annotation data packet information may include the document on which the annotation is made, the page number of the document on which the annotation is made, the pen used to make the annotation, the x coordinate of the annotation, or the y coordinate of the annotation.

In this example, the metadata information identifies all annotation data packets. In this manner, a “late joiner” will receive all annotations made to the document.

In view of the structure, functions and operations of the illustrative embodiments described above, the present invention provides techniques for selectively sharing portions of screen data from a presenter's display with one or more attendee's in a screen sharing session, such as an online meeting or a web conference. The present invention provides privacy to elements of the presenter's screen desired to be hidden from attendees' or otherwise not screen shared. This enables the presenter to interact with his computing environment in a manner where the presenter can be less concerned with showing attendees certain aspects of his interactions, such as reviewing information on the screen desired to be kept confidential or that may otherwise be sensitive information of the presenter. Furthermore, the present invention may also provide a more efficient screen sharing mechanism where the presenter does not need to be so concerned with the effect on the screen sharing from controlling and managing the online meeting. For example, using the techniques of the present invention, the presenter can deploy the control panel with less concern about the impact on the visual aspects and flow of the presentation. The attendee's will not see the deployed control panel in their screen sharing view.

Additionally, the selective sharing techniques can be practiced with bandwidth-adaptive communication systems and methods. This allows for the selective sharing to be provided to attendees and presenters having different network bandwidths and to provide for more efficient and reliable transmission of screen data between the presenter's computing device and the computing devices of the attendees. Also, the present invention provides for representing the screen and forming screen data using a tile-based technique. This enables for the coordination and synchronization of changes to screen data between a presenter and attendee's respective computers. The tile-based technique provides an efficient means for updating attendee's screen data during or after using a screen sharing technique described above.

Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are to be read as including what they set forth literally and also those equivalent elements which are insubstantially different, even though not identical in other respects to what is shown and described in the above illustrations.

We claim:

1. A method for selectively sharing screen data between a first computing device and a second computing device, the second computing device displaying screen data of the first computing device, the method comprising the steps of:
(a) transmitting screen data displayed by the first computing device to a second computing device, the screen data including a user interface element having a deployed state and an undeployed state;
(b) detecting that the user interface element is in the deployed state; and
(c) suspending transmission of screen data to the second computing device.

2. The method of claim 1, further comprising the steps of:
(d) detecting the user interface element transitioned from the deployed state to the undeployed state; and
(e) resuming transmission of screen data to the second computing device.

3. The method of claim 1, further comprising the step of displaying by the first computing device an indication that transmission of screen data to the second computing device is suspended.

4. The method of claim 1, wherein the user interface element comprises a user interface element selected from the group consisting of: a control panel, a dialog, a popup menu, a tool tip, a chat bubble, and a system bubble.

5. The method of claim 1, wherein the user interface element comprises a communication selected from the group consisting of: a private, a sensitive, and a confidential communication of a user.

6. The method of claim 1, further comprising detecting a change to the first computing device's screen during the suspension of transmission of screen data.

7. The method of claim 6, further comprising queuing a portion of screen data representing the screen change.

8. The method of claim 7, further comprising discarding the portion of screen data after a predetermined time period.

9. The method of claim 7, further comprising transmitting the portion of screen data to the second computing device upon resuming transmission of screen data.

10. The method of claim 1, comprising representing portions of the first computing device's screen as a plurality of tiles.

11. The method of claim 10, detecting a change to a first tile of the plurality of tiles, and providing a data packet for transmission to the second computing device, the data packet representing the change to the first tile.

12. The method of claim 11, wherein transmitting further comprises synchronizing the data packet with the second computing device using a bandwidth-adaptive mechanism.

13. The method of claim 1, wherein the undeployed state comprises the user interface element being one of minimized or not displayed.

14. A system for selectively sharing screen data between a first computing device and a second computing device, the second computing device displaying screen data of the first computing device, the system comprising:
a transmitter for transmitting screen data displayed by a first computing device to a second computing device, the screen data including a user interface element having a deployed state and an undeployed state;
a detector for detecting a state of the user interface element; and
wherein in response to the detector detecting the user interface element is in the deployed state, the transmitter suspends transmission of screen data to the second computing device.

15. The system of claim 14, wherein the detector detects the user interface element transitioning from the deployed state to the undeployed state, and in response to the detector, the transmitter resumes transmission of screen data to the second computing device.

16. The system of claim 14, comprising an indicator displayed on the first computing device identifying the suspension of transmission of screen data to the second computing device.

17. The system of claim 14, wherein the user interface element comprises a user interface element selected from the group consisting of: a control panel, a dialog, a popup menu, a tool tip, a chat bubble, and a system bubble.

18. The system of claim 14, wherein the user interface element comprises a communication selected from the group consisting of: a private, a sensitive, or a confidential communication of a user.

19. The system of claim 14, comprising a screen change detector detecting a screen change during the suspension of transmission of screen data.

20. The system of claim 19, comprising a queuing mechanism for queuing screen data, the queuing mechanism queuing a portion of screen data representing the screen change.

21. The system of claim 20, wherein the queuing mechanism discards the portion of screen data after a predetermined time period.

22. The system of claim 20, wherein the transmitter transmits the portion of screen data to the second computing device upon resuming transmission of screen data.

23. The system of claim 16, comprising a plurality of tiles representing portions of the first computing device's screen.

24. The system of claim 23, comprising a screen change detector detecting a change to a portion of the screen represented by a first tile of the plurality of tiles.

25. The system of claim 24, comprising a data packet for transmission to the second computing device, the data packet comprising a representation of the change to the first tile.

26. The system of claim 25, wherein the transmitter comprises a bandwidth-adaptive mechanism to synchronize the data packet with the second computing device.

27. The system of claim 14, wherein the undeployed state of the user interface element comprises one of minimized or not displayed.

28. A system for selectively sharing screen data between a first computing device and a second computing device, the second computing device displaying screen data of the first computing device, the system comprising:
a means for transmitting screen data displayed by a first computing device to a second computing device, the screen data including a user interface element having a deployed state and an undeployed state;
a means for detecting a state of the user interface element; and
a means for suspending transmission of screen data to the second computing device in response to detecting the user interface element is in the deployed state.

29. The system of claim 28, comprising a means for detecting the user interface element transitioning from the deployed state to the undeployed state, and a means for resuming the transmission of screen data to the second computing device.

30. The system of claim 28, comprising a means for providing an indicator displayed on the first computing device identifying the suspension of the transmission of screen data to the second computing device.

31. The system of claim 28, wherein the user interface element comprises a user interface element selected from the group consisting of: a control panel, a dialog, a popup menu, a tool tip, a chat bubble, and a system bubble.

32. The system of claim 28, wherein the user interface element comprises a communication selected from the group consisting of: a private, a sensitive, or a confidential communication of a user.

33. The system of claim 28, comprising a means for detecting a change to the first computing device's screen during the suspension of transmission of screen data.

34. The system of claim 28, comprising a means for queuing a portion screen data representing the screen change

35. The system of claim 28, comprising a means for discarding the portion of screen data after a predetermined time period.

36. The system of claim 28, comprising a means for transmitting the portion of screen data to the second computing device upon resuming transmission of screen data.

37. The system of claim 28, comprising a means for representing portions of the first computing device's screen as a plurality of tiles.

38. The system of claim 37, comprising a means for detecting a change to a portion of the screen represented by a first tile of the plurality of tiles.

39. The system of claim 38, comprising a means for providing a data packet for transmission to the second computing device, the data packet comprising a representation of the change to the first tile.

40. The system of claim 38, comprising a means for synchronizing the data packet with the second computing device using a band-width adaptive mechanism.

41. The system of claim 28, wherein the undeployed state of the user interface element comprises one of minimized or not displayed.
